(19) United States
(12) Patent Application Publication
(10) Pub. No.: US 2025/0379698 A1
(43) Pub. Date: Dec. 11, 2025

(54) METHOD, USER EQUIPMENT AND ACCESS NETWORK NODE

(71) Applicant: NEC Corporation, Minato-ku, Tokyo (JP)

(72) Inventor: Pravjyot DEOGUN, Milton Keynes (GB)

(73) Assignee: NEC Corporation, Minato-ku, Tokyo (JP)

(21) Appl. No.: 18/877,580

(22) PCT Filed: Jul. 31, 2023
(86) PCT No.: PCT/JP2023/027893

§ 371 Date: Dec. 20, 2024

(30) Foreign Application Priority Data
Aug. 12, 2022 (GB) 2211851.7

(51) Int. Cl. H04L 5/00; H04L 5/14; H04W 24/10; H04W 72/0446; H04W 72/231

(52) U.S. Cl. CPC H04L 5/0051; H04L 5/14; H04W 24/10; H04W 72/0446; H04W 72/231

(57) ABSTRACT

In a first example aspect, a method performed by a user equipment (UE) includes: receiving, from an access network node: first information indicating a first configuration related to transmission of a reference signal in a first time resource configured for a non-subband full duplex (SBFD), and second information indicating a second configuration related to transmission of a reference signal in a second time resource configured for aSBFD; and performing measurement of a reference signal transmitted in a time resource based on: the first information, the second information, and third information indicating whether a respective time resource is valid for transmitting the reference signal.

### TECHNICAL FIELD

The present disclosure relates to a method, a user equipment and an access network node.

### BACKGROUND ART

In mobile communication, time division duplex (TDD) schemes have been employed especially for higher frequency bands, whereas in TDD the time domain resource is split between DL and UL.

Full duplex (FD) operation, involving sharing both frequency domain and time domain resources between the UL and the DL, within the bandwidth of a conventional TDD carrier, represents one way in which improvements may be achievable over conventional TDD performance. Accordingly, enhancements to implement full duplex operation at gNB, within TDD carriers, are currently being developed.

### CITATION LIST

### Non Patent Literature

NPL 1: 3GPP TS38.214 V17.2.0
NPL 2: 3GPP TS38.213 V17.2.0
NPL 3: 3GPP TS38.321 V17.1.0

### SUMMARY OF INVENTION

### Technical Problem

However, possible FD implementations may cause interference such as base station to base station (e.g., inter-gNB) cross link interference (CLI), base station self-interference and UE to UE (inter-UE) CLI.

An example of the object of the present disclosure is to provide a method, a user equipment and an access network node capable of reducing interference in communication.

### Solution to Problem

In a first example aspect, a method performed by a user equipment (UE) includes: receiving, from an access network node: first information indicating a first configuration related to transmission of a reference signal in a first time resource configured for a first communication scheme, and second information indicating a second configuration related to transmission of a reference signal in a second time resource configured for a second communication scheme; and performing measurement of a reference signal transmitted in a time resource based on: the first information, the second information, and a communication scheme configuring the time resource used in transmitting the reference signal.

In a second example aspect, a method performed by a user equipment (UE) includes: performing a uplink transmission in a second time resource configured for a second communication scheme based on a second uplink transmission configuration defined for uplink transmission in the second time resource configured for the second communication scheme, wherein the second uplink transmission configuration is different from a first uplink transmission configuration defined for uplink transmission in a first time resource configured for a first communication scheme.

In a third example aspect, a method performed by an access network node includes: transmitting, to a user equipment (UE): first information indicating a first configuration related to transmission of a reference signal in a first time resource configured for a first communication scheme, and second information indicating a second configuration related to transmission of a reference signal in a second resource configured for a second communication scheme; and receiving, from the UE, a report of measurement of a reference signal transmitted in a time resource, wherein the report includes information based on: the first information, the second information, and a communication scheme configuring the time resource used in transmitting the reference signal.

In a fourth example aspect, a method performed by an access network node includes: receiving, from a user equipment (UE), a uplink transmission in a second time resource configured for a second communication scheme based on a second uplink transmission configuration defined for uplink transmission in the second time resource configured for the second communication scheme, wherein the second uplink transmission configuration is different from a first uplink transmission configuration defined for uplink transmission in a first time resource configured for a first communication scheme.

In a fifth example aspect, a user equipment (UE) includes: means for receiving, from an access network node: first information indicating a first configuration related to transmission of a reference signal in a first time resource configured for a first communication scheme, and second information indicating a second configuration related to transmission of ta reference signal in a second time resource configured for a second communication scheme; and means for performing measurement of a reference signal transmitted in a time resource based on: the first information, the second information, and a communication scheme configuring the time resource used in transmitting the reference signal.

In a sixth example aspect, a user equipment (UE) includes: means for performing a uplink transmission in a second time resource configured for a second communication scheme based on a second uplink transmission configuration defined for uplink transmission in the second time resource configured for the second communication scheme, wherein the second uplink transmission configuration is different from a first uplink transmission configuration defined for uplink transmission in a first time resource configured for a first communication scheme.

In a seventh example aspect, an access network node includes: means for transmitting, to a user equipment (UE): first information indicating a first configuration related to transmission of a reference signal in a first time resource configured for a first communication scheme, and second information indicating a second configuration related to transmission of a reference signal in a second time resource configured for a second communication scheme; and means for receiving, from the UE, a report of measurement of a reference signal transmitted in a time resource, wherein the report includes information based on: the first information, the second information, and a communication scheme configuring the time resource used in transmitting the reference signal.

In an eighth example aspect, an access network node includes: means for receiving, from a user equipment (UE), a uplink transmission in a second time resource configured for a second communication scheme based on a second uplink transmission configuration defined for uplink transmission in the second time resource configured for the second communication scheme, wherein the second uplink transmission configuration is different from a first uplink transmission configuration defined for uplink transmission in a first time resource configured for a first communication scheme.

### Advantageous Effects of Invention

According to the present disclosure, it is possible to provide a method, a user equipment and an access network node capable of reducing interference in communication.

### BRIEF DESCRIPTION OF DRAWINGS

Embodiments of the disclosure will now be described, by way of example, with reference to the accompanying drawings in which:

FIG. 1A is a time frequency diagram illustrating a subband non-overlapping full duplex scheme and various exemplary implementations of such a scheme;

FIG. 1B is a time frequency diagram illustrating a subband non-overlapping full duplex scheme and various exemplary implementations of such a scheme;

FIG. 1C is a time frequency diagram illustrating a subband non-overlapping full duplex scheme and various exemplary implementations of such a scheme;

FIG. 1D is a time frequency diagram illustrating a subband non-overlapping full duplex scheme and various exemplary implementations of such a scheme;

FIG. 2 schematically illustrates a mobile (‘cellular’ or ‘wireless’) telecommunication system;

FIG. 3 illustrates a typical frame structure that may be used in the telecommunication system of FIG. 2;

FIG. 4 is a simplified sequence diagram illustrating different slot configuration procedures that can be employed in the telecommunication system of FIG. 2;

FIG. 5 shows illustrative examples of slot configurations configured by the procedures of FIG. 4;

FIG. 6 is a simplified time frequency diagram showing an illustrative example of full duplex configuration that may be used in the telecommunication system of FIG. 2;

FIG. 7 is a simplified illustration of an antenna panel configuration for a base station of the telecommunication system of FIG. 2;

FIG. 8 is a simplified illustration of an example of how logical antenna ports may be configured for MIMO and and/or beamforming;

FIG. 9 illustrates a number of information elements that may be used for such measurement signalling in a 5G system;

FIG. 10 illustrates a different respective use case for CSI-RS measurements for supporting transmission of data (via the PDSCH) and associated DMRS;

FIG. 11 illustrates a different respective use case for CSI-RS measurements for supporting transmission of data (via the PDSCH) and associated DMRS;

FIG. 12 illustrates a different respective use case for CSI-RS measurements for supporting transmission of data (via the PDSCH) and associated DMRS;

FIG. 13 is a simplified illustration of an exemplary mapping between CSI-RS ports, logical antenna elements, and physical antenna elements;

FIG. 14 is a simplified illustration of a number of different CSI-RS to logical antenna array configurations for a single panel antenna;

FIG. 15 is a simplified illustration of a number of different CSI-RS to logical antenna array configurations for a multi-panel antenna;

FIG. 16 illustrates the number of horizontal beams and vertical beams that may be configured per CSI-RS resource for the configurations of FIG. 14;

FIG. 17A illustrates exemplary power control equations that may be used in the telecommunication system of FIG. 2;

FIG. 17B illustrates exemplary power control equations that may be used in the telecommunication system of FIG. 2;

FIG. 18 is a simplified illustration of an antenna panel configuration for full duplex communication in the telecommunication system of FIG. 2;

FIG. 19 is another simplified illustration of an antenna panel configuration for full duplex communication in the telecommunication system of FIG. 2;

FIG. 20 is a simplified sequence diagram illustrating another procedure that can be employed in the telecommunication system of FIG. 2;

FIG. 21 illustrates an exemplary implementation of the procedure of FIG. 20;

FIG. 22 is a simplified sequence diagram illustrating another procedure that can be employed in the telecommunication system of FIG. 2;

FIG. 23 is a simplified sequence diagram illustrating another procedure that can be employed in the telecommunication system of FIG. 2;

FIG. 24 is a simplified sequence diagram illustrating another procedure that can be employed in the telecommunication system of FIG. 2;

FIG. 25 is a simplified sequence diagram illustrating another procedure that can be employed in the telecommunication system of FIG. 2;

FIG. 26A illustrates a different possible technique that may be employed for CSI reporting in the telecommunication system of FIG. 2;

FIG. 26B illustrates a different possible technique that may be employed for CSI reporting in the telecommunication system of FIG. 2;

FIG. 26C illustrates a different possible technique that may be employed for CSI reporting in the telecommunication system of FIG. 2;

FIG. 26D illustrates a different possible technique that may be employed for CSI reporting in the telecommunication system of FIG. 2;

FIG. 27A illustrates another different possible technique that may be employed for CSI reporting in the telecommunication system of FIG. 2;

FIG. 27B illustrates another different possible technique that may be employed for CSI reporting in the telecommunication system of FIG. 2;

FIG. 28 illustrates a potential relationship between CSI-reporting and downlink data transmission;

FIG. 29 is a simplified sequence diagram illustrating a number of different procedures that can be employed for updating transmission parameters in the telecommunication system of FIG. 2;

FIG. 30 is a simplified timing diagram illustrating a technique that may be used for reducing the CSI-RS transmission overhead in the telecommunication system of FIG. 2;

FIG. 31 is a simplified timing diagram illustrating another technique that may be used for reducing the CSI-RS transmission overhead in the telecommunication system of FIG. 2;

FIG. 32 is a schematic block diagram illustrating the main components of a UE for the telecommunication system of FIG. 2; and

FIG. 33 is a schematic block diagram illustrating the main components of a base station for the telecommunication system of FIG. 2.

### DESCRIPTION OF EMBODIMENTS

### Related Arts

Recent developments of the 3GPP standards are referred to as the Long Term Evolution (LTE) of Evolved Packet Core (EPC) network and Evolved UMTS

Terrestrial Radio Access Network (E-UTRAN), also commonly referred as ‘4G’. In addition, the term ‘5G’ and ‘new radio’ (NR) refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network.

Under the 3GPP standards, a NodeB (or an eNB in LTE, gNB in 5G) is the radio access network (RAN) node (or simply ‘access node’, ‘access network node’ or ‘base station’) via which communication devices (user equipment or ‘UE’) connect to a core network and communicate with other communication devices or remote servers. For simplicity, the present application will use the term RAN node or base station to refer to any such access nodes.

In the current 5G architecture, for example, the gNB structure may be split into two parts known as the Central Unit (CU) and the Distributed Unit (DU), connected by an F1 interface. This enables the use of a ‘split’ architecture, whereby the, typically ‘higher’, CU layers (for example, but not necessarily or exclusively), PDCP and the, typically ‘lower’, DU layers (for example, but not necessarily or exclusively, RLC/MAC/PHY) to be implemented separately. Thus, for example, the higher layer CU functionality for a number of gNBs may be implemented centrally (for example, by a single processing unit, or in a cloud-based or virtualised system), whilst retaining the lower layer DU functionality locally, in each gNB.

For simplicity, the present application will use the term mobile device, user device, or UE to refer to any communication device that is able to connect to the core network via one or more base stations. Although the present application may refer to mobile devices in the description, it will be appreciated that the technology described can be implemented on any communication devices (mobile and/or generally stationary) that can connect to a communications network for sending/receiving data, regardless of whether such communication devices are controlled by human input or software instructions stored in memory.

Historically, communication systems have employed two core duplex schemes-frequency division duplex (FDD) and time division duplex (TDD). In FDD the frequency domain resource is split between downlink (DL) and uplink (UL) whereas in TDD the time domain resource is split between DL and UL.

The appropriate duplex scheme to be used in a given scenario is broadly spectrum dependent, albeit with some overlap. Where lower frequency bands are used for communication, paired spectrum UL and DL resource allocations are generally employed and hence FDD is used. In contrast, for higher frequency bands the use of unpaired spectrum, and hence TDD, is becoming increasingly prevalent. Thus, TDD is widely used in commercial NR deployments. Given the significantly higher carrier frequencies supported by 5G, and that will be supported by future communication generations (6G and beyond) as compared to earlier communication generations, improved techniques for providing efficient use of unpaired spectrum are, and will continue to be, increasingly critical.

However, allocation of too limited a time duration for the UL in TDD carriers has the potential to result in reduced coverage, increased latency, and reduced capacity.

Full duplex (FD) operation, involving sharing both frequency domain and time domain resources between the UL and the DL, within the bandwidth of a conventional TDD carrier, represents one way in which improvements may be achievable over conventional TDD performance. Accordingly, enhancements to implement full duplex operation at the gNB, within TDD carriers, are currently being developed-currently with no restriction on the possible frequency ranges used for such FD operation. At present half duplex operation within TDD carriers is still envisaged for the UE, although full duplex UE operation remains an option for the future. The use of FD has, however, the potential to cause serious interference issues, both at the base station and at the UE, which are difficult to address.

There are a number of possible FD implementations that can be implemented on TDD carriers including, for example, subband non-overlapping, subband overlapping, full overlapping.

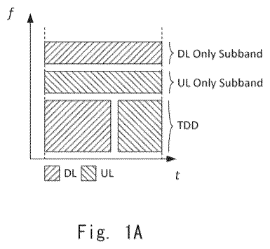

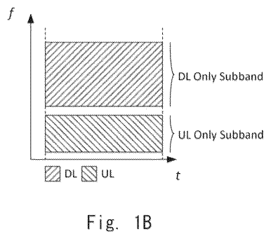

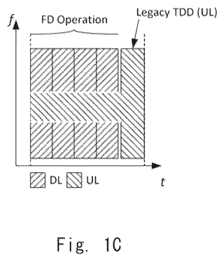

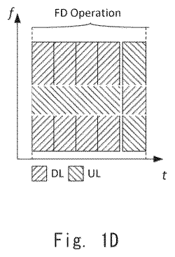

Referring to FIGS. 1A to 1D, in subband non-overlapping FD (′SBFD′, also referred to as cross division duplex (XDD)), non-overlapping UL and DL subbands may be configured in the TDD carrier (as seen in the general case illustrated in FIG. 1A). As seen in FIGS. 1A to 1D each subband comprises a respective relatively ‘narrow’ frequency band having a bandwidth that extends only part of the full available bandwidth within the current TDD carrier that is configured for communication in the associated cell. A base station can thus perform simultaneous (full duplex) transmission and reception at the same time, in different respective non-overlapping subbands, for different UEs.

FIG. 1B shows a particular example in which only one dedicated DL subband and one dedicated UL subband are configured in the TDD carrier. FIG. 1C shows an example in which, from the first slot to the fourth slot, full duplex operation is active where an UL subband is present in the centre of the frequency band and two DL subbands are present at either side of the DL subband. In the fifth slot, the base station uses legacy TDD operation (i.e. entire frequency band is used only for UL). FIG. 1D shows an example in which, from the first slot to the fifth slot, full duplex operation is active. In the first four slots an UL subband is present in the centre of the frequency band and two DL subbands are present at either side of the DL subband. In the fifth slot a complementary UL/DL configuration is present compared to the first four slots.

In subband overlapping FD, UL and DL may be configured in a similar way to subband non-overlapping FD, but the different subbands are allowed to overlap in frequency.

In full overlapping FD, the entire available bandwidth may be used for UL or DL transmissions.

### (Problem of Related Arts)

Currently, focus is on the development of techniques for implementing subband non-overlapping FD operation and potential related enhancements for dynamic or flexible TDD. It will be appreciated, however, that other FD implementations remain an option for the future and enhancements envisaged for sub-band non-overlapping FD may have benefits in other FD schemes.

Among the interference issues that need to be considered are base station to base station (e.g., inter-gNB) CLI, base station self-interference and UE to UE (inter-UE) CLI.

The inter-gNB CLI may be due, for example, to adjacent-channel CLI, co-channel-CLI (or both) depending on the deployment scenario.

Inter-UE CLI may, for example, comprise CLI arising between UEs in the same cell (intra-cell CLI) as a result of both DL and UL transmissions can running in parallel. In this scenario, interference may be observed by a UE, in the DL, from an adjacent subband which is used for UL transmission from another UE in the same cell. Such interference may, for example, arise due to non-linear distortions or frequency errors (e.g. doppler spread for DL reception). Interference may be expected, in particular, to be apparent for DL frequency resources which are close to UL resource elements (REs). This can become a severe issue when interference is experienced for DL reference signal (RS) reception (e.g., reception of Channel State Information RS (CSI-RS)) which has the potential to reduce system efficiency.

The base station self-interference on receiving UL may be due to adjacent-channel CLI of DL transmission from the same base station at the same time occasion. Such interference may, for example, arise due to non-linear distortions or frequency errors. Interference may be expected, in particular, to be apparent for UL frequency resources which are close to DL resource elements (REs). This can become a severe issue when interference is experienced for UL reference signal (RS) reception (e.g., reception of Sounding Reference Signal (SRS) which has the potential to reduce system efficiency.

For subband non-overlapping FD operation both within subband (intra-subband) CLI and subband to subband (inter-subband) may be particularly relevant.

It can be seen, therefore, that there is a need for enhancements to help enable efficient dynamic/flexible TDD in communication networks. The enhancements may, for example, include techniques for effectively managing CLI handling between the base stations (of the same or different operators) and/or between the UEs, and/or mitigating or avoiding CLI. The development of such techniques needs to consider a number of differing and sometimes conflicting factors related to the potential performance of the techniques and their impact on legacy operation (assuming their co-existence with legacy operation in co-channel and adjacent channels). These factors may include, for example, the more general requirements of low latency, improved capacity, support for dynamic FD configuration change, reduced/minimised CLI, and appropriate support for interworking with legacy (e.g., legacy NR) UEs and base stations. Such techniques also need to be developed with due consideration for the potential impacts on current technology, for example the NR Frame structure, DL/UL resource allocation, inter-gNB signalling, and/or interference measurement procedures.

### (Explanation of the Disclosure)

The disclosure aims to provide apparatus and methods that at least partially address the above needs and/or issues.

As discussed above, one of the major issues facing the development of an appropriate FD scheme for TDD, subband non-overlapping full duplex, is the potential for high interference at the base stations during UL reception due, for example, to simultaneous DL transmission in the same frequency band. The inventor has considered a number of options for support full duplex communication in time division duplex (TDD) communication bands that may mitigate this interference and/or its effects including, for example, provision of a frequency gap (or guard band) between UL and DL subbands, providing for intelligent beam scheduling between UL and DL (e.g. scheduling the UL and the DL in orthogonal beams), the use of digital Interference cancellation algorithms in the UL chain, and/or the segregation of antenna elements between UL and DL (e.g., such that the UL and the DL use different set of antenna elements). In the present disclosure a number of techniques are disclosed for supporting full duplex communication in time division duplex (TDD) communication bands, in particular by supporting the segregation of antenna elements between UL and DL.

### (Description of Aspects)

This disclosure describes multiple aspects and variants for each instance. These aspects and variants can be arbitrarily combined with each other.

The present disclosure relates to a communication system. The disclosure has particular but not exclusive relevance to wireless communication systems and devices thereof operating according to the 3GPP standards or equivalents or derivatives thereof (including LTE-Advanced, Next Generation or 5G networks, future generations, and beyond). The disclosure has particular, although not necessarily exclusive relevance to, improved apparatus and methods that support full duplex communication in time division duplex (TDD) communication bands.

In one aspect the disclosure provides a method performed by a user equipment (UE), the method comprising: receiving, from an access network node: first information indicating a first configuration related to transmission of at least one downlink reference signal in at least one time resource configured for a first communication scheme, and second information indicating at least one of: a second configuration related to transmission of the at least one downlink reference signal in at least one time resource configured for a second communication scheme; or that the at least one downlink reference signal will not be transmitted in at least one time resource; performing at least one measurement of the at least one downlink reference signal transmitted in at least one time resource based on at least one of: the first information, or the second information; and transmitting at least one report to the access network node based on the at least one measurement, wherein the at least one report includes information based on at least one of: the first information, or the second information.

The first communication scheme may correspond to downlink communication. The second communication scheme may correspond to full duplex communication. The second information may indicate at least one of: a power value, or an antenna port configuration, for transmission of the at least one downlink reference signal in the at least one time resource configured for the second communication scheme, that is different from a corresponding at least one of: a power value, or antenna port configuration, for transmission of the at least one downlink reference signal in the at least one time resource configured for the first communication scheme.

The second information may indicate an antenna port configuration, to be used for transmission of the at least one downlink reference signal in the at least one time resource configured for the second communication scheme, that is different from another antenna port configuration to be used for transmission of the at least one downlink reference signal in the at least one time resource configured for the first communication scheme. The second information may indicate a frequency resource configuration, to be used for transmission of the at least one downlink reference signal in the at least one time resource configured for the second communication scheme, that is different from another frequency resource configuration to be used for transmission of the at least one downlink reference signal in the at least one time resource configured for the first communication scheme. The second information may indicate the frequency resource configuration by indicating a subset of at least one frequency resource configured by the first configuration that is punctured, or that is not punctured, in at least one time resource configured for the second communication scheme.

The first configuration may include: a first parameter set including at least one first parameter related to the transmission of the at least one downlink reference signal in the at least one time resource configured for the first communication scheme; and a second parameter set including at least one second parameter related to the transmission of the at least one downlink reference signal in the at least one time resource configured for the second communication scheme; and the second information may indicate the at least one second parameter by reference to the first information.

The first parameter set may relate to a first report configuration for transmitting the at least one report related to the transmission of the at least one downlink reference signal in the at least one time resource configured for the first communication scheme, and the second parameter set may relate to a second report configuration for transmitting the at least one report related to the transmission of the at least one downlink reference signal in the at least one time resource configured for the second communication scheme.

The second information may be received from the access network node in downlink control information for transmitting the at least one report related to the transmission of the at least one downlink reference signal. The second information may indicate that, for at least one time occasion, at least one downlink reference signal will not be transmitted in at least one downlink reference signal resource during that at least one time occasion.

The second information may define at least one downlink reference signal resource for which transmission will not be performed during the at least one time occasion, and the method may further comprise determining at least one time occasion for which transmission will be restricted based on the at least one time resource configured for the second communication scheme.

The at least one time resource configured for the second communication scheme may be configured based on at least one time resource configuration of a plurality of possible time resource configurations for the second communication scheme, and the at least one time occasion for which transmission will be restricted may be determined based on the at least one time resource configuration that the at least one time resource configured for the second communication scheme is configured based on.

In one aspect the disclosure provides a method performed by a user equipment (UE), the method comprising: receiving, from an access network node, a report configuration for at least one downlink reference signal transmitted within a time window; and in a case where at least one time resource within the time window is configured for a second communication scheme, sending, to the access network node, based on the report configuration, information based on at least one of: measurement in respect of at least one downlink reference signal configured for a first communication scheme; or partial measurement in respect of at least one downlink reference signal transmitted in the at least one time resource configured for the second communication scheme; or omitting sending information to the access network node based on the report configuration.

The first communication scheme may correspond to downlink communication. The second communication scheme may correspond to full duplex communication.

In a case where at least one time resource within the time window is configured for the second communication scheme, the method may comprise sending, to the access network node, information based on measurement in respect of at least one downlink reference signal configured for the first communication scheme without information based on partial measurement in respect of at least one downlink reference signal transmitted in the at least one time resource configured for the second communication scheme.

In a case where at least one time resource within the time window is configured for the second communication scheme, the method may comprise sending, to the access network node, information based on partial measurement in respect of at least one downlink reference signal configured for the first communication scheme and based on partial measurement in respect of at least one downlink reference signal transmitted in the at least one time resource configured for the second communication scheme.

In a case where at least one time resource within the time window is configured for the second communication scheme, the method may comprise sending, to the access network node, information based on partial measurement in respect of at least one downlink reference signal transmitted in the at least one time resource configured for the second communication scheme without information based on measurement in respect of at least one downlink reference signal transmitted in the at least one time resource configured for the first communication scheme.

In a case where at least one time resource within the time window is configured for the second communication scheme, the method may comprise sending, to the access network node, information based on complete measurement, in accordance with the report configuration, in respect of at least one downlink reference signal configured for the first communication scheme and based on partial measurement in respect of at least one downlink reference signal transmitted in the at least one time resource configured for the second communication scheme.

In one aspect the disclosure provides a method performed by a user equipment (UE), the method comprising: performing at least one uplink transmission in at least one time resource configured for a second communication scheme based on a first uplink transmission configuration defined for uplink transmission in the at least one time resource configured for the second communication scheme, wherein the first uplink transmission configuration is different from a second uplink transmission configuration defined for uplink transmission in at least one time resource configured for a third communication scheme.

The second communication scheme may correspond to full duplex communication. The third communication scheme may correspond to uplink communication.

The first uplink transmission configuration may include at least one power value to be applied in respect of uplink transmission in the at least one time resource configured for the second communication scheme that is different from at least one corresponding power value, included in the second uplink transmission configuration, to be applied in respect of uplink transmission in the at least one time resource configured for the third communication scheme.

The method may further comprise receiving an indication of the at least one power value from an access network node. The indication of the at least one power value may indicate at least one specific power value to be applied in respect of the uplink transmission in the at least one time resource configured for the second communication scheme. The first uplink transmission configuration may include an encoding rule to be applied in respect of uplink transmission in the at least one time resource configured for the second communication scheme that is different from another encoding rule, included in the second uplink transmission configuration, to be applied in respect of uplink transmission in the at least one time resource configured for the third communication scheme. The first uplink transmission configuration may include a number of repetitions to be applied in respect of uplink transmission in the at least one time resource configured for the second communication scheme that is different from another number of repetitions, included in the second uplink transmission configuration, to be applied in respect of uplink transmission in the at least one time resource configured for the third communication scheme.

The first uplink transmission configuration may include a random access channel (RACH) format to be applied in respect of uplink transmission in the at least one time resource configured for the second communication scheme that is different to another RACH format, included in the second uplink transmission configuration, to be applied in respect of uplink transmission in the at least one time resource configured for the third communication scheme.

In one aspect the disclosure provides a method performed by an access network node, the method comprising: transmitting, to a user equipment (UE): first information indicating a first configuration related to transmission of at least one downlink reference signal in at least one time resource configured for a first communication scheme, and second information indicating at least one of: a second configuration related to transmission of the at least one downlink reference signal in at least one time resource configured for a second communication scheme; or that the at least one downlink reference signal will not be transmitted in at least one time resource; receiving at least one report from the UE based on the at least one measurement, wherein the at least one report includes information based on at least one of: the first information, or the second information.

In one aspect the disclosure provides a method performed by an access network node, the method comprising: transmitting, to a user equipment (UE), a report configuration for at least one downlink reference signal transmitted within a time window; and in a case where at least one time resource within the time window is configured for a second communication scheme, receiving, from the UE, based on the report configuration, information based on at least one of: measurement in respect of at least one downlink reference signal configured for a first communication scheme; or partial measurement in respect of at least one downlink reference signal transmitted in the at least one time resource configured for the second communication scheme.

In one aspect the disclosure provides a method performed by an access network node, the method comprising: receiving, from a user equipment (UE) at least one uplink transmission in at least one time resource configured for a second communication scheme based on a first uplink transmission configuration defined for uplink transmission in the at least one time resource configured for the second communication scheme, wherein the first uplink transmission configuration is different from a second uplink transmission configuration defined for uplink transmission in at least one time resource configured for a third communication scheme.

In one aspect the disclosure provides a user equipment (UE) comprising: means for receiving, from an access network node: first information indicating a first configuration related to transmission of at least one downlink reference signal in at least one time resource configured for a first communication scheme, and second information indicating at least one of: a second configuration related to transmission of the at least one downlink reference signal in at least one time resource configured for a second communication scheme; or that the at least one downlink reference signal will not be transmitted in at least one time resource; means for performing at least one measurement of the at least one downlink reference signal transmitted in at least one time resource based on at least one of: the first information, or the second information; and means for transmitting at least one report to the access network node based on the at least one measurement, wherein the at least one report includes information based on at least one of: the first information, or the second information.

In one aspect the disclosure provides a user equipment (UE) comprising: means for receiving, from an access network node, a report configuration for at least one downlink reference signal transmitted within a time window; and means for, in a case where at least one time resource within the time window is configured for a second communication scheme, sending, to the access network node, based on the report configuration, information based on at least one of: measurement in respect of at least one downlink reference signal configured for a first communication scheme; or partial measurement in respect of at least one downlink reference signal transmitted in the at least one time resource configured for the second communication scheme; or omitting sending information to the access network node based on the report configuration.

In one aspect the disclosure provides a user equipment (UE) comprising: means for performing at least one uplink transmission in at least one time resource configured for a second communication scheme based on a first uplink transmission configuration defined for uplink transmission in the at least one time resource configured for the second communication scheme, wherein the first uplink transmission configuration is different from a second uplink transmission configuration defined for uplink transmission in at least one time resource configured for a third communication scheme.

In one aspect the disclosure provides an access network node comprising: means for transmitting, to a user equipment (UE): first information indicating a first configuration related to transmission of at least one downlink reference signal in at least one time resource configured for a first communication scheme, and second information indicating at least one of: a second configuration related to transmission of the at least one downlink reference signal in at least one time resource configured for a second communication scheme; or that the at least one downlink reference signal will not be transmitted in at least one time resource; means for receiving at least one report from the UE based on the at least one measurement, wherein the at least one report includes information based on at least one of: the first information, or the second information.

In one aspect the disclosure provides an access network node comprising: means for transmitting, to a user equipment (UE), a report configuration for at least one downlink reference signal transmitted within a time window; and means for, in a case where at least one time resource within the time window is configured for a second communication scheme, receiving, from the UE, based on the report configuration, information based on at least one of: measurement in respect of at least one downlink reference signal configured for a first communication scheme; or partial measurement in respect of at least one downlink reference signal transmitted in the at least one time resource configured for the second communication scheme.

In one aspect the disclosure provides an access network node comprising: means for receiving, from a user equipment (UE) at least one uplink transmission in at least one time resource configured for a second communication scheme based on a first uplink transmission configuration defined for uplink transmission in the at least one time resource configured for the second communication scheme, wherein the first uplink transmission configuration is different from a second uplink transmission configuration defined for uplink transmission in at least one time resource configured for a third communication scheme.

It will be appreciated that while the communication system to which the present application relates is described in the context of full duplex enhancement at the base station side, half duplex operation at the UE side, and no restriction on the frequency ranges; the enhancements described may have benefit in other communication systems. For example, communication systems in which the UE is capable of full duplex operation and/or there are restrictions on the frequency ranges that may be used.

### (Overview)

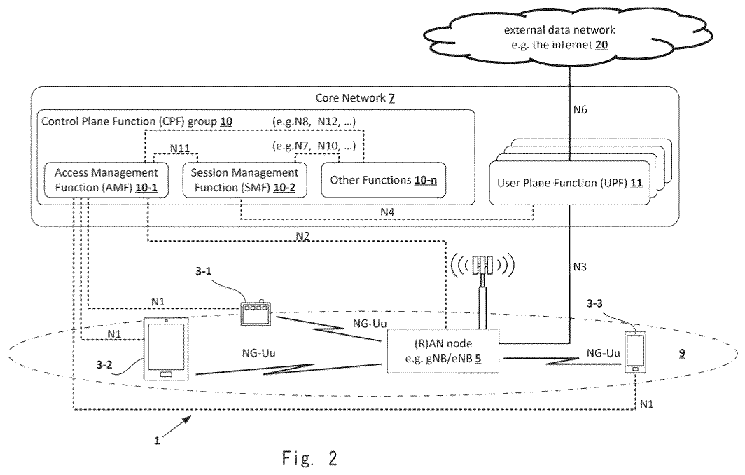

An exemplary telecommunication system will now be described in general terms, by way of example only, with reference to FIGS. 2 to 19.

FIG. 2 schematically illustrates a mobile (‘cellular’ or ‘wireless’) telecommunication system 1 to which embodiments of the present disclosure are applicable.

In the communication system 1, user equipment (UEs) 3-1, 3-2, 3-3 (e.g. mobile telephones and/or other mobile devices) can communicate with each other via a radio access network (RAN) node 5 that operates according to one or more compatible radio access technologies (RATs). In the illustrated example, the RAN node 5 comprises a NR/5G base station or ‘gNB’ 5 operating one or more associated cells 9. Communication via the base station 5 is typically routed through a core network 7 (e.g. a 5G core network or evolved packet core network (EPC)).

As those skilled in the art will appreciate, whilst three UEs 3 and one base station 5 are shown in FIG. 2 for illustration purposes, the system, when implemented, will typically include other base stations and UEs.

Each base station 5 controls one or more associated cells 9 either directly, or indirectly via one or more other nodes (such as home base stations, relays, remote radio heads, distributed units, and/or the like). It will be appreciated that the base stations 5 may be configured to support 4G, 5G, 6G, and/or any other 3GPP or non-3GPP communication protocols.

The UEs 3 and their serving base station 5 are connected via an appropriate air interface (for example the so-called ‘Uu’ interface and/or the like). Neighbouring base stations 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the telecommunication system 1. In this example, the core network 7 comprises control plane functions (CPFs) 10 and one or more user plane functions (UPFs) 11. The CPFs 10 include one or more Access and Mobility Management Functions (AMFs) 10-1, one or more Session Management Functions (SMFs) and a number of other functions 10-n.

The base station 5 is connected to the core network nodes via appropriate interfaces (or ‘reference points’) such as an N2 reference point between the base station 5 and the AMF 10-1 for the communication of control signalling, and an N3 reference point between the base station 5 and each UPF 11 for the communication of user data. The UEs 3 are each connected to the AMF 10-1 via a logical non-access stratum (NAS) connection over an N1 reference point (analogous to the SI reference point in LTE). It will be appreciated, that N1 communications are routed transparently via the base station 5.

One or more UPFs 11 are connected to an external data network (e.g. an IP network such as the internet) 20 via reference point N6 for communication of the user data.

The AMF 10-1 performs mobility management related functions, maintains the non-NAS signalling connection with each UE 3 and manages UE registration. The AMF 10-1 is also responsible for managing paging. The SMF 10-2 provides session management functionality (that formed part of MME functionality in LTE) and additionally combines some control plane functions (provided by the serving gateway and packet data network gateway in LTE). The SMF 10-2 also allocates IP addresses to each UE 3.

The base station 5 of the communication system 1 is configured to operate at least one cell 9 on an associated TDD carrier that operates in unpaired spectrum. It will be appreciated that the base station 5 may also operate at least one cell 9 on an associated FDD carrier that operates in paired spectrum.

The base station 5 is also configured for transmission of, and the UEs 3 are configured for the reception of, control information and user data via a number of downlink (DL) physical channels and for transmission of a number of physical signals. The DL physical channels correspond to resource elements (REs) carrying information originated from a higher layer, and the DL physical signals are used in the physical layer and correspond to REs which do not carry information originated from a higher layer.

The physical channels may include, for example, a physical downlink shared channel (PDSCH), a physical broadcast channel (PBCH), and a physical downlink control channel (PDCCH). The PDSCH carries data sharing the PDSCH's capacity on a time and frequency basis. The PDSCH can carry a variety of items of data including, for example, user data, UE-specific higher layer control messages mapped down from higher channels, system information blocks (SIBs), and paging. The PDCCH carries downlink control information (DCI) for supporting a number of functions including, for example, scheduling the downlink transmissions on the PDSCH and also the uplink data transmissions on the physical uplink shared channel PUSCH. The PBCH provides UEs 3 with the Master Information Block, MIB. It also, in conjunction with the PDCCH, supports the synchronisation of time and frequency, which aids cell acquisition, selection and re-selection.

The DL physical signals may include, for example, reference signals (RSs) and synchronization signals (SSs). A reference signal (sometimes known as a pilot signal) is a signal with a predefined special waveform known to both the UE 3 and the base station 5. The reference signals may include, for example, cell specific reference signals, UE-specific reference signal (UE-RS), downlink demodulation signals (DMRS), and channel state information reference signal (CSI-RS).

Similarly, the UEs 3 are configured for transmission of, and the base station 5 is configured for the reception of, control information and user data via a number of uplink (UL) physical channels corresponding to REs carrying information originated from a higher layer, and UL physical signals which are used in the physical layer and correspond to REs which do not carry information originated from a higher layer. The physical channels may include, for example, a physical uplink shared channel (PUSCH), a physical uplink control channel (PUCCH), and/or a physical random-access channel (PRACH). The UL physical signals may include, for example, demodulation reference signals (DMRS) for a UL control/data signal, and/or sounding reference signals (SRS) used for UL channel measurement.

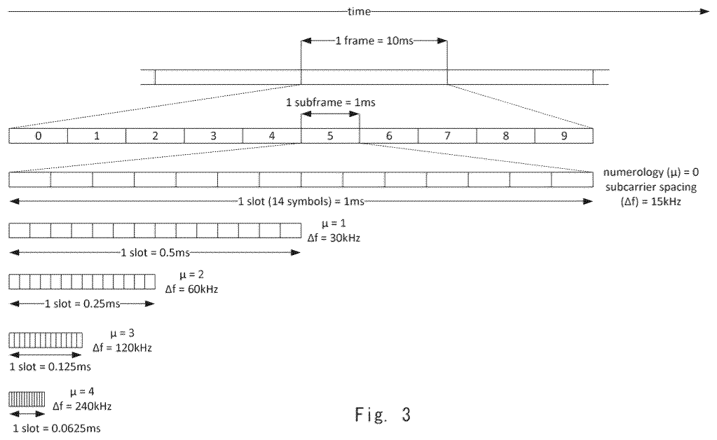

Referring to FIG. 3, which illustrates the typical frame structure that may be used in the telecommunication system 1, the base station 5 and UEs 3 of the telecommunication system 1 communicate with one another using resources that are organised, in the time domain, into frames of length 10 ms. Each frame comprises ten equally sized subframes of Ims length. Each subframe is divided into one or more slots comprising 14 Orthogonal frequency-division multiplexing (OFDM) symbols of equal length.

As seen in FIG. 3, the communication system 1 supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of μ can, in effect, be derived from μ=0 by scaling up in powers of 2 (i.e. SCS=15×2^{μ} kHz). The relationship between the parameter, μ, and SCS (Δf) is as shown in Table 1:

TABLE 1

| | | Number of slots | |
|---|---|---|---|
| μ | Δf = 2^{μ} · 15 [kHz] | per subframe | Slot length (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

Table 1 above shows one example of 5G Numerology.

### <General Slot Configuration>

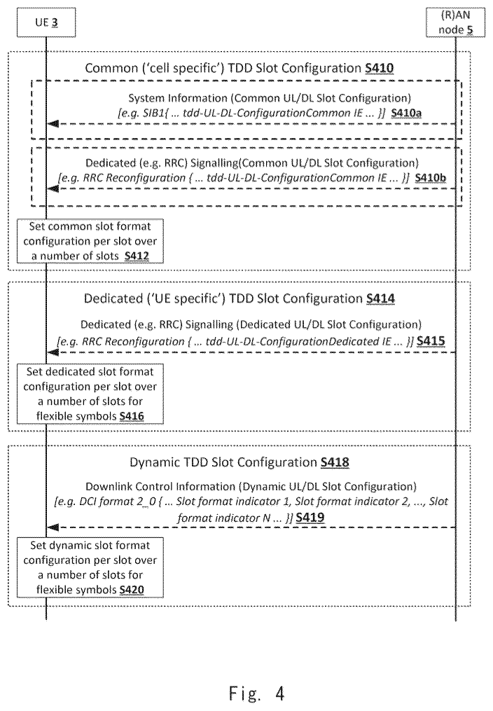

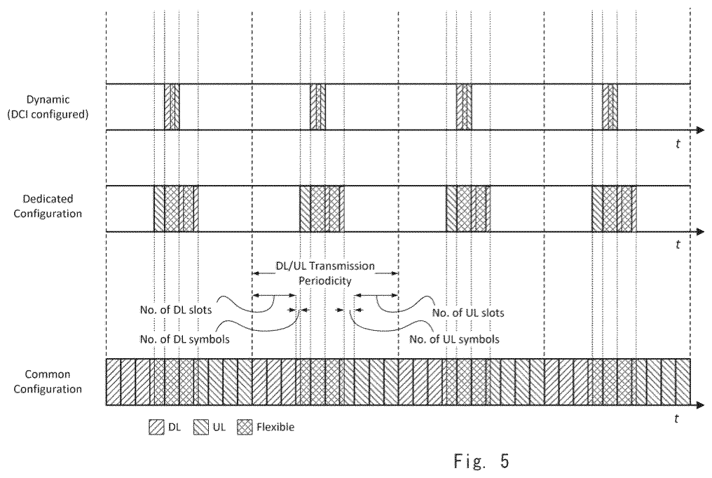

Referring to FIGS. 4 and 5 the base station 5 configures the slot usage within each cell 9 operated on a TDD carrier appropriately.

As seen in FIG. 4, which is a simplified sequence diagram illustrating different slot configuration procedures (S410, S414, S418) that can be employed in the communication system 1, the base station 5 is capable of employing a number of different procedures for configuring slot usage in each cell 9 operated on the TDD carrier.

As seen in procedure S410, for example, the base station 5 of the communication system 1 is configured for providing a respective common (or ‘cell specific’) slot configuration, for each cell 9 operated on a TDD carrier. This common slot configuration can be provided using system information (as illustrated at S410a) to all UEs 3 within the cell (for example in a tdd-UL-DL-ConfigurationCommon information element (IE) of system information block type 1 (SIB1)). This common slot configuration can also be provided using dedicated (e.g., radio resource control (RRC)) signalling (as illustrated at S410b) to specific UEs 3 within the cell (for example in a tdd-UL-DL-ConfigurationCommon IE of an RRC message such as an RRC reconfiguration message or the like). On receipt of the common slot configuration a UE 3 can thus set a common slot format configuration per slot over a number of slots (as seen at S412).

As seen in FIG. 5, which shows illustrative examples of slot configurations configured by the procedures of FIG. 4, the slots may be configured as downlink only slots, as uplink only slots, or as unallocated or ‘flexible’ slots (that may be downlink or uplink).

The common slot configuration is defined by a number of parameters provided by the base station 5 as part of the common UL/DL configuration. These parameters include: a slot configuration period (e.g., configured by a dl-UL-TransmissionPeriodicity IE); a number of slots with only downlink symbols (e.g., configured by a nrofDownlinkSlots IE); a number of downlink symbols (e.g., configured by a nrofDownlinkSymbols IE); a number of slots with only uplink symbols (e.g., configured by a nrofUplinkSlots IE); and a number of uplink symbols (e.g., configured by a nrofUplinkSymbols IE). As seen in FIG. 5, these effectively configure a repeating pattern of slot types (repeating at the slot configuration period), which in this example comprises DL only slots and symbols, followed by flexible slots and symbols, followed by UL only slots and symbols. The repeating pattern starts with a DL group comprising the defined number of DL only slots followed by the defined number of DL only symbols in the next slot. The repeating pattern ends with a UL group comprising the defined number of UL only slots preceded by the defined number of UL only symbols in the preceding slot. The flexible symbols and slots are those, between the DL group of DL only slots and symbols and the UL group of UL only slots and symbols.

As seen in procedure S414, the base station 5 of the communication system 1 is also configured for providing, if required, a dedicated (or ‘UE specific’) slot configuration for a specific UE 3. This dedicated slot configuration can be provided using dedicated (e.g., radio resource control (RRC)) signalling (as illustrated at S415) to a specific UE 3 within the cell (for example in a tdd-UL-DL-ConfigurationDedicated IE of an RRC message such as an RRC reconfiguration message or the like).

If a UE 3 is provided with the dedicated slot configuration in addition to the common slot configuration, then the dedicated slot configuration overrides only the symbols and slots configured as flexible symbols and slots, per slot, over the number of slots configured by the common slot configuration (as seen in the example of FIG. 5).

The dedicated configuration, if provided, includes one or more individual slot specific configurations (e.g., using a slotSpecificConfigurationsToAddModList IE) in which each slot configuration contains information (e.g., a slotindex IE) identifying a specific slot within the slot configuration period defined by the common slot configuration, and information defining a symbol structure (e.g., a symbols IE). The information defining the symbol structure provides the direction (downlink or uplink) for the symbols within the specific slot that is being configured. The information defining the symbols structure may, for example: indicate that all symbols in the specific slot are used for the downlink (e.g., by setting the symbols IE to ‘allDownlink’); indicate that all symbols in the specific slot are used for the uplink (e.g., by setting the symbols IE to ‘allUplink’); or explicitly indicate how many symbols at the beginning and the end of the specific slot are allocated to downlink and uplink, respectively (e.g., a nrofDownlinkSymbols IE may indicate the number of consecutive downlink symbols in the beginning of the slot identified by the slot index, and a nrofUplinkSymbols IE may indicate the number of consecutive uplink symbols at the end of the slot identified by the slot index).

A UE 3 can thus set a dedicated slot format configuration per slot over a number of slots (as seen at S416).

A UE 3 thus teats symbols in a slot indicated as downlink by the common slot configuration, or the dedicated slot configuration to be available for receptions. Similarly, a UE 3 teats symbols in a slot indicated as uplink by the common slot configuration, or the dedicated slot configuration to be available for transmissions.

Even after the slot configurations in a cell-specific and UE-specific manner described above, the slot configuration may have some more flexible slots/symbols left unallocated. By making use of layer 1 signalling, the remaining (if any) flexible symbols can dynamically be reconfigured.

As seen in procedure S418, for example, the base station 5 of the communication system 1 is also configured for providing one or more dynamic slot configurations to a group of one or more UEs 3 by means of a physical downlink control channel (PDCCH). One or more dynamic slot configurations can be provided using downlink control information (DCI) using an appropriate DCI format (e.g., DCI format 2_0), as illustrated at S419, to a specific group of one or more UEs 3 within the cell 9.

Indexes of one or more slot format indicators (SFIs) are provided within the payload of the DCI for the group of one or more UEs 3. To allow the DCI to be addressed to, and decoded by, one or more UEs 3 of the group cyclic redundancy check (CRC) bits of the DCI are scrambled with an associated radio network temporary identifier (RNTI), for example an ‘SFI-RNTI’ and one or more UEs in the group are allocated with the same RNTI. Each UE 3 of the group is configured to extract its own SFI-index based on the position of the SFI-index within the DCI payload (this position may, for example, be configured by UE specific RRC signalling). The RRC configuration may, for example, be by means of an RRC message carrying a PDCCH serving cell configuration IE having a slot format indicator (SFI) IE that, for a specific serving cell (identified by a serving cell ID (e.g., by a servingCellId IE)): provides an SFI-RNTI; defines one or more slot format combinations (e.g., by a slotFormatCombinations IE); and specifies the starting position (bit), in the DCI, of the SFI index that is applicable for the configured UE (e.g., by a positionInDCI IE).

Each SFI-index provided by the DCI acts as a pointer to a combination of slot formats (where each slot format corresponds to a respective combination of downlink, uplink, and/or flexible symbols) for defining a slot format for each slot in a number of slots starting from a slot where the UE detects the dynamic slot configuration DCI format.

Thus, for any slot indicated to a UE as flexible by both a common slot configuration and a dedicated slot configuration, the DCI can be used to dynamically configure downlink, uplink, and/or flexible symbols within that slot (as seen in the example of FIG. 5).

A UE 3 can thus set a dynamic slot format configuration per slot over a number of slots (as seen at S420).

### <Bandwidth Parts (BWPs)>

In the communication system 1 the cell bandwidth can be divided into multiple bandwidth parts (BWPs) that each start at a respective common resource block (RB) and respectively comprises of a set of contiguous RBs with a given numerology (sub-carrier spacing, ‘SCS’, and cyclic prefix, ‘CP’) on a given carrier. It will be appreciated that conventionally the number of downlink symbols, uplink symbols, and flexible symbols in each slot of the slot configuration (e.g., common or dedicated) would be common to each configured BWP.

The UEs 3 and base station 5 of the communication system 1 are thus configured for operation using BWPs. For each serving cell of a UE 3, the base station 5 can configure at least one downlink (DL) BWP (e.g. an initial DL BWP). The base station 5 may configure the UE 3 with up to a maximum (typically four) DL BWPs with only a single DL BWP being active at a given time. The UE 3 is not expected to receive PDSCH, PDCCH, or CSI-RS (except for radio resource management (RRM)) outside an active bandwidth part. Where the serving cell is configured with an uplink (UL), the base station 5 can configure at least one UL BWP (e.g. an initial UL BWP). The base station 5 may configure the UE 3 with up to a maximum (typically four) UL BWPs with only one UL BWP being active at a given time. The UE 3 does not transmit PUSCH or PUCCH outside an active bandwidth part. For an active cell, the UE 3 does not transmit SRS outside an active bandwidth part. It will be appreciated that the slot format indicator (e.g., an SFI-index field value) in the dynamic slot configuration DCI format may indicate to a UE 3 a slot format for each slot in a number of slots for each DL BWP or each UL BWP.

A BWP identifier or index (BWP-ID) is used to refer to BWPs (in UL and DL independently). Various radio resource control (RRC) configuration procedures can thus use the BWP-ID to associate themselves with a particular BWP.

While for paired spectrum (FDD), DL BWPs and UL BWPs are configured separately, for unpaired spectrum (TDD), a DL BWP is effectively linked to (paired with) a UL BWP, with the paired DL BWP and UL BWP sharing the same BWP-ID and centre frequency (but possibly different bandwidths).

Specifically, the base station 5 is able to configure an initial DL BWP (e.g. by means of an initialDownlinkBWP IE) via system information (e.g. system information block 1, ‘SIB1’) and/or via dedicated (e.g. RRC) signalling (e.g. an RRC reconfiguration, RRC resume, or RRC setup message). For example, the common parameters for the initial DL BWP may be provided via system information whereas UE specific parameters may be provided via dedicated signalling (e.g. in a ServingCellConfig IE within an RRC message that contains a dedicated, UE-specific, BWP configuration). The dedicated signalling may also contain some cell-specific information which may be useful for specific scenarios (e.g. handover).

The base station 5 is able to configure an initial UL BWP (e.g. by means of an initialUplinkBWP IE) via system information (e.g. system information block 1, ‘SIB1’) and/or via dedicated (e.g. RRC) signalling (e.g. an RRC reconfiguration, RRC resume, or RRC setup message). For example, the common parameters for one or more initial UL BWPs may be provided via system information whereas UE specific parameters may be provided via dedicated signalling (e.g. in a ServingCellConfig IE within an RRC message that contains a dedicated, UE-specific, BWP configuration). This provides configuration information either for a so-called special cell (SpCell)—which is a PCell of a master cell group (MCG) or secondary cell group (SCG)—or a secondary cell (SCell).

The initial DL and UL BWPs are used at least for initial access before an RRC connection is established. The initial BWP is known as BWP #0 as it has a BWP identifier (or ‘index’) of zero. Prior to receiving system information defining a UE's initial DL BWP, the DL BWP for each UE 3 has a frequency range and numerology corresponding to a control resource set (CORESET)—e.g. CORESET #0—defined by a master information block (MIB) (or possibly dedicated RRC signalling). The CORESET is used to carry downlink control information (DCI) transmitted via a physical downlink control channel (PDCCH) for scheduling system information blocks.

After receiving the system information (e.g. SIB1) a UE 3 uses the BWP configuration defined by that system information to configure the initial DL BWP and initial UL BWP. The configured initial UL BWP is then used to initiate a random-access procedure for setting up an RRC connection. The base station 5 configures the frequency domain location and bandwidth of the initial DL BWP in the system information so that the initial DL BWP contains the entire CORESET #0 in the frequency domain.

For each DL BWP in a set of DL BWPs for a primary cell, a UE 3 can be configured with CORESETs for every type of common search space (CSS) set and for a UE-specific search space (USS) set. For each UL BWP in a set of UL BWPs of a primary cell, or of a PUCCH-secondary cell, the UE 3 is configured resource sets for PUCCH transmissions.

The UE 3 is configured for switching its active BWP between its configured BWPs when required. For example, switching at the UE 3 may be initiated by receipt of a scheduling DCI, by expiry of an inactivity timer (e.g., a BWPInactivityTimer), and/or by initiation of a random-access procedure.

### <Provision of Full Duplex>

The UEs 3 and base station 5 of the communication system 1 are mutually configured for providing full duplex (FD) communication on a TDD carrier. Specifically, the UEs 3 and base station 5 of the communication system 1 are configured to facilitate subband non-overlapping FD communication.

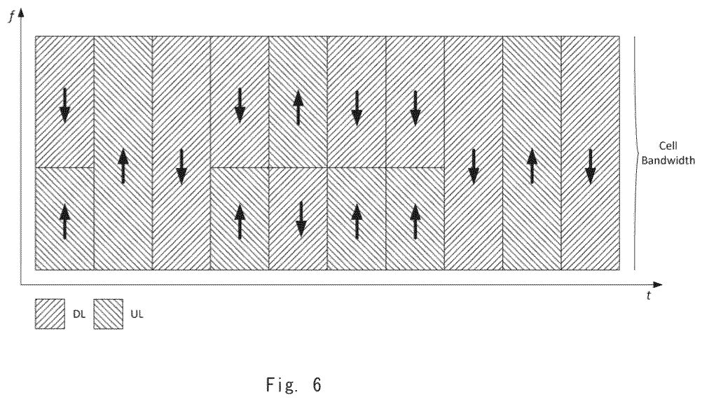

For example, as seen in FIG. 6, which is a simplified time frequency diagram showing an illustrative example of a full duplex configuration that may be used in the communication system 1, the different UE specific slot configurations allow a slot within the cell bandwidth to effectively be configured as an FD slot by configuring that slot for one UE as an uplink slot, while the same slot is configured as a downlink slot for another UE (or vice versa). Thus, UL communication from one UE 3 in the cell bandwidth may occur in parallel with DL communication to another UE 3. It will be appreciated that while not specifically illustrated the parallel UL/DL communication may be configured at a symbol level as well as at the slot level.

It will be appreciated that the base station 5 is configured to schedule frequency resources of any slot configured as an FD slot, to ensure that the frequency resources scheduled for UL communication by one UE 3 are part of a different subband than the frequency resources scheduled for DL communication to another UE 3. Accordingly, subband non-overlapping FD communication can thus take place at the base station 5 while half-duplex communication takes place at the UEs 3.

The base station 5 is thus able to configure one or more of the slots (and/or symbols) of the TDD carrier as FD slots (and/or symbols) or more specifically, in a case where, subband non-overlapping full duplex (SBFD) is used for full duplex operation, SBFD slots (and/or symbols). For convenience, the following terminologies will generally be used: ‘SBFD slot’ for a slot including, from the base station's perspective, both DL and UL subbands; legacy DL slot for a slot including, from the base station's perspective, only DL; and legacy UL slot (or simply UL slot) for a slot including, from the base station's perspective, only UL.

It will be appreciated that, from a UE perspective, an SBFD slot or symbol may appear to be a legacy UL, DL, or flexible symbol because the UE 3 is operating using half duplex on the TDD carrier. Nevertheless, a UE 3 may be informed of the FD/SBFD slots/symbols, either implicitly or explicitly, to allow the UE 3 to assist with interference avoidance/alleviation. For example, if the UE 3 can identify the FD/SPFD slots/symbols then the UE 3 may: contribute to the implementation of an appropriate frequency gap between the frequency resources used by that UE 3 (e.g., for UL or DL) and the frequency resources used by another UE 3 (e.g., for DL or UL); avoid, reconfigure, and/or apply updated resources, in respect of certain transmissions/receptions (e.g., for semi-static transmission such as SPS.

For example, the base station 5 may explicitly indicate which slots/symbols are configured as FD/SBFD type slots/symbols, for example, dynamically using DCI with an appropriate DCI format and/or using a Medium Access Control (MAC) Control Element (CE). The base station 5 may, alternatively or additionally explicitly indicate which slots/symbols are configured as FD/SBFD type slots/symbols via system information or dedicated (RRC) signalling (for example, by means of frame structure signalling similar to that used for the cell specific and/or dedicated TDD UL/DL slot configuration). A UE 3 may implicitly determine whether a slot/symbol is configured as an FD/SBFD type slots/symbol based on other information received from the network (base station 5). For example, the UE may assume that an SBFD slot occurs when the base station 5 indicates that an UL transmission is to take place during a DL configured slot or that a DL transmission is to take place during a UL configured slot.

For each DL or UL channel where parameters are different for an SBFD slot than for a non-SBFD slot, the base station 5 may indicate, within a physical channel configuration, the time occasions where one set of parameters are to be used and the time occasions where second set of parameters are to be used. For CSI-RS, the time occasions may be indicated within an associated CSI report configuration (as described in more detail later).

For each DL or UL channel where different resources are configured for an SBFD slot than for a non-SBFD slot, the base station 5 may indicate within a physical channel resource configuration, the time occasions where each resource is valid/applicable. For CSI-RS, the time occasions may be indicated within an associated CSI report configuration (as described in more detail later).

It will be appreciated that the communication system 1 may be configured to provide support for any suitable subband non-overlapping FD schemes. Such schemes may include, for example, inter-BWP full duplex and/or intra-BWP full duplex. Inter-BWP full duplex involves parallel UL and DL transmission in different BWPs in which a particular slot of one BWP may be configured as an uplink slot while the corresponding slot (i.e., having the same timing) in another BWP may be configured as a downlink slot (or vice versa). Thus, UL from one UE 3 in one BWP may occur in parallel with DL communication to another UE 3 in another BWP. Inter-BWP full duplex, on the other hand, involves parallel UL and DL transmission in different BWPs in which different UE specific slot configurations allow a slot of a particular BWP to effectively be configured as an FD slot by configuring that slot for one UE as an uplink slot, while the same slot in the same BWP is configured as a downlink slot for another UE (or vice versa). Thus, UL communication from one UE 3 in that BWP may occur in parallel with DL communication to another UE 3 in the same BWP.

### <Antenna Panel Configuration>

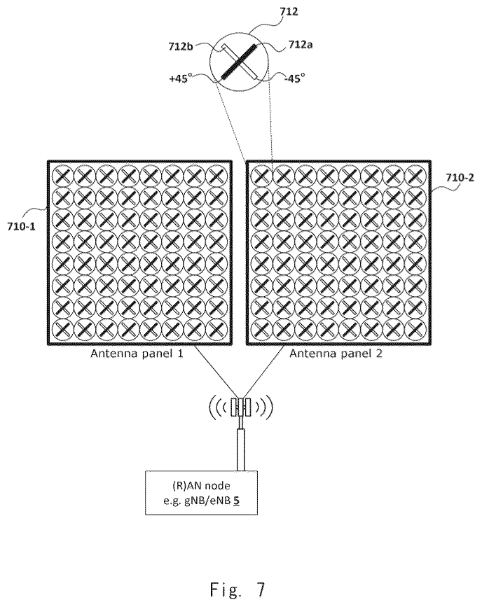

Referring to FIG. 7, which is a simplified illustration of an antenna panel configuration for a base station 5, the base station 5 of the communication system 1 includes an antenna that has a plurality of antenna panels 710-1, 710-2 (two in this example although more are possible). Each antenna panel 710 comprises a plurality of physical antenna elements 712a, 712b arranged in cross-polar pairs of antenna elements 712. In the illustrated example each cross-polar pair 712 comprises a plus 45° antenna element 712a and a minus 45° antenna element 712b although it will be appreciated that other arrangements are possible. In FIG. 7, each antenna panel 710 is shown, for illustrative purposes, to comprise an 8×8 array of 64 cross-polar pairs of antenna elements 712 (128 physical antenna elements 712a, 712b).

It will be appreciated that while the base station 5 is described as having a plurality of antenna panels the base station 5 (or another similar base station 5 of the communication system 1) may have a single panel because at least some operators currently support a single antenna panel per base station site. It will also be appreciated that the number of antenna elements is not restricted to 128 physical antenna elements (64 cross-polar pairs). One or more antenna panels may, for example include 64 physical antenna elements (in 32 cross-polar pairs), 32 physical antenna elements (in 16 cross-polar pairs), etc.

The UE 3 also has an antenna having multiple antenna elements.

The use of antennas with multiple physical antenna elements allows the base station 5 and UE 3 to perform transmissions (and receptions) using logical antenna ports that are mapped to a subset of one or more of the physical antenna elements 712. Transmissions sharing the same antenna port will therefore experience the same propagation channel.

The use of logical antenna ports at the base station 5 or UE 3 allows multiple input multiple output (MIMO) communication in which plural streams of data (referred to as ‘transmission layers’) may be transmitted (or received), in parallel, using the same time and frequency resources but via different logical antenna ports. Moreover, the ability to map a given logical antenna port to a subset including a plurality of physical antenna elements allows the base station 5 or UE 3 to beamform transmissions made via that logical antenna port (i.e., by applying an appropriate amplitude and/or phase adjustments at each physical antenna element).

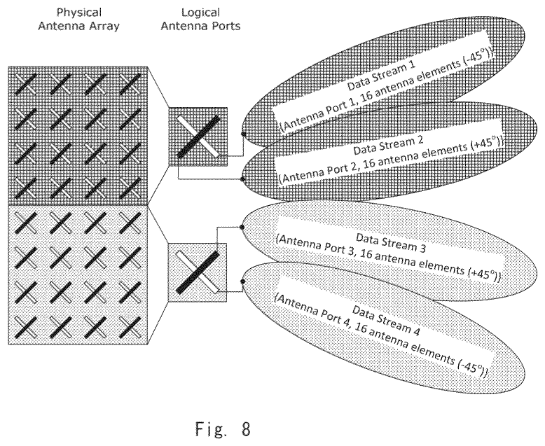

FIG. 8 illustrates a simplified example of how logical antenna ports may be configured for MIMO and and/or beamforming. As seen in FIG. 8, the simplified example involves a single panel array of 64 physical antenna elements (32 cross-polar pairs (+45°/−45°)). There are, in the example, four distinct MIMO transmission layers (e.g., for 4×4 MIMO) each of which is transmitted via a different respective set of 16 physical antenna elements that is mapped to a corresponding antenna port. As each antenna port is mapped to multiple physical antenna elements beamforming is possible and hence the respective data streams transmitted for each transmission layer can be beamformed to form a corresponding beam as illustrated.

With no precoding an original signal, SN, transmitted in a particular data stream/transmission layer from transmitter antenna port, N, and received at receiver antenna port, M, will be affected by the propagation channel, hMN, between those antenna ports. A signal, YM, received at receiver antenna port, M, will thus correspond to the sum of each original signal as modified by the respective propagation channel. This may be represented mathematically using matrix algebra. For example, for the simplified case of two transmitter antenna ports and two receiver antenna ports (e.g., 2×2 MIMO), the received signals may be represented as follows:

$${Y}_{1} = {h}_{11} {S}_{1} + {h}_{12} {S}_{2} , \qquad [ Equation 1 a ]$$

$$and$$

$${Y}_{2} = {h}_{21} {S}_{1} + {h}_{22} {S}_{2} . \qquad [ Equation 1 b ]$$

Where Y is the received signal vector, e.g.,

$$[ \begin{matrix}{Y}_{1} \\ {Y}_{2}\end{matrix} ] ,$$

S is the original signal vector, e.g.,

$$[ \begin{matrix}{S}_{1} \\ {S}_{2}\end{matrix} ] ,$$

and H is the propagation channel coefficient matrix, e.g.,

$$[ \begin{matrix}{h}_{11} & {h}_{12} \\ {h}_{21} & {h}_{22}\end{matrix} ] ,$$

this may be generally represented using matrix representation as Y=HS, or more specifically for the 2×2 MIMO example:

$$[ \begin{matrix}{Y}_{1} \\ {Y}_{2}\end{matrix} ] = [ \begin{matrix}{h}_{11} & {h}_{12} \\ {h}_{21} & {h}_{22}\end{matrix} ] [ \begin{matrix}{S}_{1} \\ {S}_{2}\end{matrix} ] . \qquad [ Equation 2 ]$$

As long as there is sufficient orthogonality between the respective propagation paths experienced by signals in each transmission layer, the original signals can be recovered at the receiver based on propagation coefficients derived from measurements of reference signals (e.g. DMRS) transmitted via the same propagation paths (i.e., transmitted and received by the same respective antenna ports). For example, Equation 2 may be solved by deriving an inverse channel coefficient matrix (e.g., based on reference signal measurements) and multiplying the received signals by this matrix.

Nevertheless, the propagation paths may not be completely orthogonal and, in order to improve orthogonality of the received signals precoding can be applied to the original signals before they are transmitted. Specifically, where P is the matrix of precoding parameters, e.g.,

$$[ \begin{matrix}{P}_{11} & {P}_{12} \\ {P}_{21} & {P}_{22}\end{matrix} ] ,$$

this may be generally represented using matrix representation as Y=HPS, or more specifically for the 2×2 MIMO example:

$$[ \begin{matrix}{Y}_{1} \\ {Y}_{2}\end{matrix} ] = [ \begin{matrix}{h}_{11} & {h}_{12} \\ {h}_{21} & {h}_{22}\end{matrix} ] [ \begin{matrix}{P}_{11} & {P}_{12} \\ {P}_{21} & {P}_{22}\end{matrix} ] [ \begin{matrix}{S}_{1} \\ {S}_{2}\end{matrix} ] . \qquad [ Equation 3 ]$$

### <Synchronisation Signal Blocks (SSBs)>

The base station 5 is also configured to transmit synchronisation signal blocks (SSBs) in one or more cells 9 that it operates. The SSB includes both synchronisation signals (e.g., a primary synchronisation signal (PSS) and a secondary synchronisation signal (SSS)) and a physical broadcast channel (PBCH) carrying a master information block (MIB) that provides at least part of the minimum system information for accessing the corresponding cell 9 (e.g., parameters required for acquiring system information block 1 (SIB1) which carries other minimum system information).

Each UE 3 is configured to search for synchronisation signal blocks (SSBs) when scanning for a cell to camp on and to decode the associated PBCH before proceeding to decode other system information transmitted on the PDSCH. Each UE 3 is also configured to perform measurements on the SSBs, for example reference signal received power (RSRP), reference signal received quality (RSRQ), and/or signal to interference and noise ratio (SINR) measurements or the like.

### <Channel State Information Reference Signals (CSI-RS) and Demodulation Reference Signals (DMRS)>

The base station 5 is also configured to transmit reference signals (RS) in one or more cells 9 that it operates. These reference signals include channel state information RS (CSI-RS) and demodulation RS (DMRS).

The CSI-RS may be used by the UE 3 for a number of different purposes including, for example, CSI reporting in which the UE 3 derives channel state information including one or more channel quality indicators (CQIs), rank indicators (RIs), and/or precoding matrix indicators (PMIs) from CSI-RS measurements and reports them to the base station 5 in a CSI report. The CQI is an index (typically 4 bits) value representing a signal to interference and noise ratio (SINR). The CQI value also corresponds to a modulation and coding scheme (MCS) to be used for each layer. The RI indicates a number of MIMO transmission layers requested by the UE 3 (albeit the base station 5 may not use the requested number of MIMO transmission layers). The PMI is used by the UE 3 to report parameters defining a preferred precoding matrix to be applied for downlink transmissions (albeit the base station 5 may not use the requested precoding). A layer indicator (LI) may also be included in the CSI report for identifying the strongest layer from the set of layers indicated by the RI.

The CSI-RS may also be used by the UE 3 for beam management including the refinement of initial beam selection based on SSBs. For example, the base station 5 may use a set of relatively broad beams may be used for transmission of the SSBs and a set of narrower (more directional) beams for the CSI-RS. The UE 3 can be configured, by the base station 5, to measure each CSI-RS transmission to identify the best CSI-RS beam and to report this to the base station 5 (e.g., by means of a CSI report including a CSI-RS indicator (CRI) identifying the strongest CSI-RS and hence CSI-RS beam). The UE 3 may also be configured to report the (Layer 1) RSRP which has been measured for the strongest CSI-RS.

CSI-RS may either be either zero power (ZP-CSI-RS) or non-zero power (NZP-CSI-RS). NZP-CSI-RS are used for most of the procedures including channel measurement, beam management, beam measurement, connected mode mobility etc. ZP-CSI-RS are empty resource elements, used primarily for interference measurement.

There are also several other ways in which the CSI-RS may be used including, for example, for connected mode mobility, radio link failure detection, beam failure detection/recovery, and fine timing of time and/or frequency synchronisation.

The DMRS include DMRS for the PBCH, DMRS for the PDCCH and DMRS for the PDSCH. The DMRS for the PBCH are used by the UE 3 to estimate the propagation channel experienced by the PBCH for the purposes of demodulating the PBCH and subsequent decoding of system information (e.g., carried by the MIB). The DMRS for the PDCCH are used by the UE 3 to estimate the propagation channel experienced by the PDCCH for the purposes of demodulating the PDCCH and subsequent decoding of DCI.

A DMRS for the PDSCH is transmitted in combination with the associated PDSCH using the same precoding and logical antenna ports. Accordingly, the DMRS and associated PDSCH both experience the same combined propagation channel. The DMRS is transmitted using a sequence that is known to the UE 3 and hence the UE 3 can determine the characteristics (propagation coefficients) of the propagation channel based on a comparison of the received DMRS with the original DMRS as transmitted by the base station 5. The UE 3 is then able to decode the associated PDSCH based on the derived propagation coefficients.

Data communicated on the PDSCH (and the associated DMRS) may be transmitted in parallel transmission layers and/or may be beamformed (e.g., as generally described with reference to FIGS. 7 and 8).

### <CSI Reporting>

The base station 5 can configure how the UE 3 measures and reports CSI-RS using appropriate measurement configuration signalling.

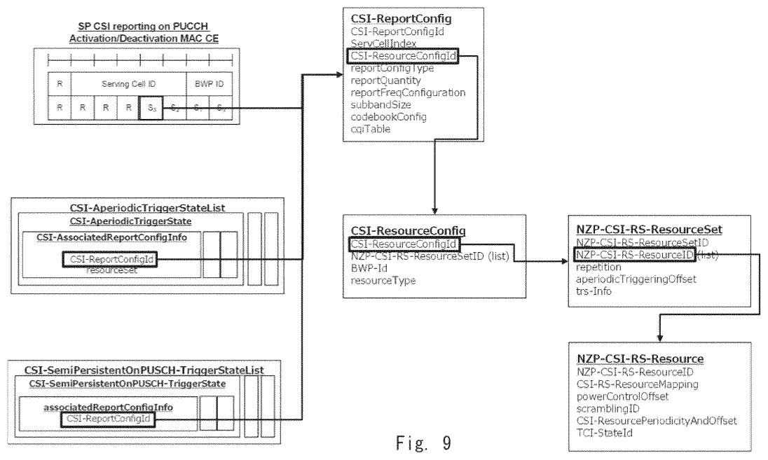

FIG. 9 illustrates a number of information elements that may be used for such measurement signalling in a 5G system according to the relevant 3GPP standards. It will be appreciated that these are shown for illustrative purposes and are purely exemplary.

The base station 5 can, for example, use the measurement configuration signalling (e.g., using a CSI-measconfig IE) to configure the UE 3 to measure and report specific resources used for CSI-RS (e.g., using the CSI-ReportConfig IE in FIG. 9). Multiple different reporting configurations can be configured and identified by an appropriate identifier (e.g., the CSI-ReportConfigID IE in FIG. 9).

The base station 5 can, for example, configure the UE 3 to provide different types of CSI reports (e.g., using the CSI-ReportConfig IE in FIG. 9) providing different information, depending on the requirements for the use case, by setting a reporting quantity parameter (e.g., the reportQuantity IE in FIG. 9) appropriately. For example, the UE 3 may be configured: to report only RI, and CQI for one or more associated CRIs, by setting the reporting quantity parameter appropriately (e.g., to cri-RI-CQI); to report RI, PMI and CQI for one or more associated CRIs by setting the reporting quantity parameter appropriately (e.g., to cri-RI-PMI-CQI), or to report RI, LI, PMI and CQI for one or more associated CRIs by setting the reporting quantity parameter appropriately (e.g., to cri-RI-LI-PMI-CQI).

Similarly, for beam management procedures, the UE 3 may be configured to report RSRP or SINR for one or more associated CRIs, by setting the reporting quantity parameter appropriately (e.g., to cri-RSRP or cri-SINR), to report RSRP or SINR for one or more associated SSBs, by setting the reporting quantity parameter appropriately (e.g., to ssb-Index-RSRP or ssb-Index-SINR).

The base station 5 can also configure the UE 3 to provide CSI reports based on different report timing configurations (e.g., using the CSI-ReportConfig IE in FIG. 9). For example, the UE 3 may be configured for persistent reporting, semi-persistent reporting on the PUSCH, semi-persistent reporting on the PUCCH, or aperiodic reporting. Aperiodic reporting and semi-persistent reporting on PUSCH may be triggered using a PUSCH DCI. For example, DCI (e.g., using DCI format 0_1) may trigger aperiodic reporting by providing a CSI request that points to a respective index of each of one or more corresponding aperiodic trigger states (e.g., configured in the CSI-AeriodicTriggerStateList IE shown in FIG. 9). Each of these trigger states is associated with one or more corresponding CSI report configurations (e.g., identified by one or more associated CSI-ReportConfig IEs in FIG. 9). Semi-persistent reporting on PUSCH may be triggered in a similar way (e.g., by identifying one or more CSI-ReportConfig IEs of one or more CSI-SemiPersistentOnPUSCH-TriggerStates listed in the CSI-SemiPersistentOnPUSCH-TriggerStateList shown in FIG. 9).

Semi-persistent reporting on PUCCH may be triggered using a MAC CE (as illustrated in the FIG. 9).

Each CSI report configuration identifies at least one CSI resource configuration (e.g., using the CSI-ResourceConfigId IE in FIG. 9) for measurement (e.g., channel measurement). The identified CSI resource configuration is defined by a corresponding IE (e.g., using the CSI-ResourceConfigId IE in FIG. 9) that includes a list of identifiers corresponding to one or more sets of CSI resources (e.g. a list of one or more NZP-CSI-RS-ResourceSetIDs for non-zero power CSI-RS as shown in FIG. 9) and associated configuration information. The associated configuration information may, for example, identifying an associated bandwidth part (e.g., by means of the BWP ID in FIG. 9) and a resource type (e.g., by means of the resourceType IE in FIG. 9). The identified resource type may, for example, identify the CSI-RS resource to be a periodic, a semi-persistent, or an aperiodic type. Each resource set comprises one or more specific CSI resource configurations represented by associated identifiers (e.g. one or more NZP-CSI-RS-ResourceIDs for non-zero power CSI-RS as shown in FIG. 9) that each point to the specific configuration information (e.g. defined by an NZP-CSI-RS-Resource IE for non-zero power CSI-RS as shown in FIG. 9) for that CSI resource configuration).

Accordingly, the base station can configure multiple CSI report configuration instances and CSI resource configuration instances. It will be appreciated that multiple resource sets can be configured per CSI resource config for the case of aperiodic CSI RS resources. The same number of CSI-RS ports are assumed for multiple CSI-RS resources within a given resource set.

In this way reporting of specific CSI resource sets for specific use cases may be configured. For example, a CSI-RS resource set may be configured that includes CSI-RS resources for different beams for beam management purposes. A CSI-RS resource set may be configured that includes a single CSI-RS resource for a number, N, of ports for channel estimation purposes.

Different resource sets may also be configured per resource configuration in for the case of multiple transmission reception points (TRPs). In this scenario, different resource sets can be part of same CSI resource configuration for aperiodic CSI reporting or can be part of different CSI resource configuration for periodic/semi-persistent CSI reporting. It will, nevertheless, be appreciated that in the case of the same number of ports for all TRPs it is possible to configure CSI-RS resources belonging to different TRPs within same resource set.

In another example, a CSI report for multiple secondary cells (SCells) can be triggered together by including CSI reporting configurations for different SCells within the information defining a single CSI aperiodic trigger state.

The base station 5 can also configure the UE 3 to provide either a wideband or a subband granularity of reporting (e.g., using a reportFreqConfiguration IE in a CSI-ReportConfig IE). For example CQI and/or partial PMI can be reported per subband setting a corresponding indicator (e.g., a cqi-FormatIndicator IE and/or a pmi-FormatIndicator IE respectively) appropriately (e.g., to widebandCQI or subbandCQI and/or to widebandPMI or subbandPMI respectively).

The base station 5 can also configure the UE 3 with a time restriction for channel measurements (and/or interference measurements). When the time restriction is configured, the UE 3 is configured to derive the measurements for computing CSI values based only on the last measured CSI-RS occasion associated with the CSI report.

It will be appreciated that the UE 3 may need to transmit quite a few CSI reports (based on the CSI configuration) but there may be limited space available in PUCCH or uplink control information (UCI) part of the PUSCH. Moreover, the CSI report payload size can increase significantly in presence of subband based reporting. Hence, prioritization rules are defined for indicating which CSI report parameters should be transmitted with the highest priority.

For CSI reporting of RI, CQI and PMI, a CSI report for a single CSI resource may be divided into two parts: a first part containing RI, CRI, CQI for a first codeword; and a second part containing PMI and CQI for a second codeword. The first part can be transmitted in whole while it is possible to omit a portion of the second part (depending on allowed size of UCI). For UCI coding, the first part of each CSI report is encoded into the UCI, and the second part of the CSI report is encoded based on amount of space available.

### <Relationship Between CSI-RS for Channel Estimation and DMRS>

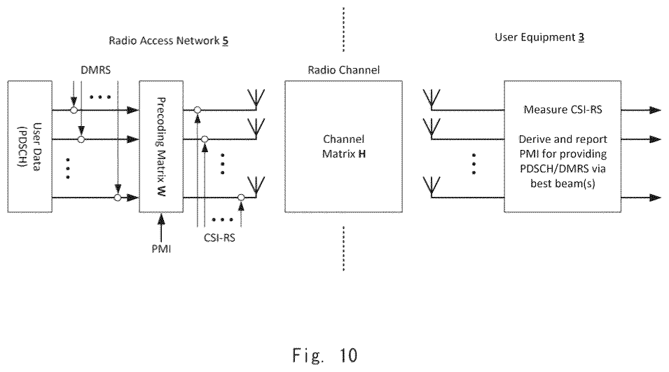

FIGS. 10 to 12 each illustrate a different respective use case for CSI-RS measurements for supporting transmission of data (via the PDSCH) and associated DMRS.

As illustrated in FIG. 10, when CSI-RS transmissions are used for PMI reporting purposes it is not always necessary to apply any CSI-RS beamforming and the CSI-RS can be transmitted directly from the physical antenna elements. In this case there is effectively a one-to-one mapping between each CSI-RS port and an associated antenna element. The lack of any CSI-RS beamforming means that the CSI-RS transmissions will radiate across the cell area with a wide beamwidth.

The UE 3 measures the CSI-RS and identifies, from a PMI codebook, a set of precoding parameters (and hence an associated PMI) which, if applied to the CSI-RS ports, would generate the best (narrow) one or more pre-coded beams towards the UE 3 using CSI-RS ports. The UE 3 reports this PMI to the base station 5 (e.g., in a CSI report including other relevant parameters such as CQI and/or RI) and the base station 5 can, if it decides to use the reported PMI, apply the precoding parameters appropriately to precode/beamform the DMRS and/or associated PDSCH based on the PMI indication.

On receipt of the PDSCH/DMRS, measurement of the DMRS can be performed in the usual way for estimation of the composite propagation channel (i.e., the propagation channel as modified by precoding/beamforming—e.g., multiplication by the precoding matrix W) and decoding of the PDSCH.

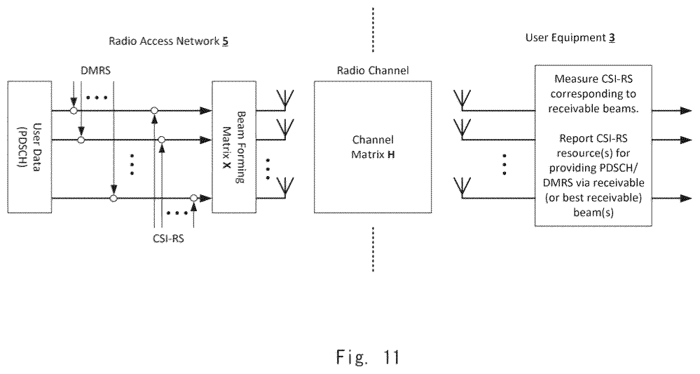

As illustrated in FIG. 11, the CSI-RS transmissions may be beamformed and each CSI-RS resource mapped to a different respective beam (and to an associated set of physical antenna elements). Since the CSI-RS is already beamformed the UE 3 measures the CSI-RS, identifies one or more directional beams on which it can successfully receive data, and reports one or more CSI-RS resources associated with one or more identified beams (or with the best identified beams) to the base station 5. Thus, the base station 5 can schedule resources for the PDSCH (and associated DMRS) using one or more identified beams and the PDSCH (and associated DMRS) can be precoded/beamformed using the same weights as were used for the CSI-RS beamforming of the identified beams.

On receipt of the PDSCH/DMRS, measurement of the DMRS can be performed in the usual way for estimation of the composite propagation channel (i.e., the propagation channel as modified by precoding/beamforming—e.g., multiplication by the beamforming precoding matrix X) and decoding of the PDSCH.

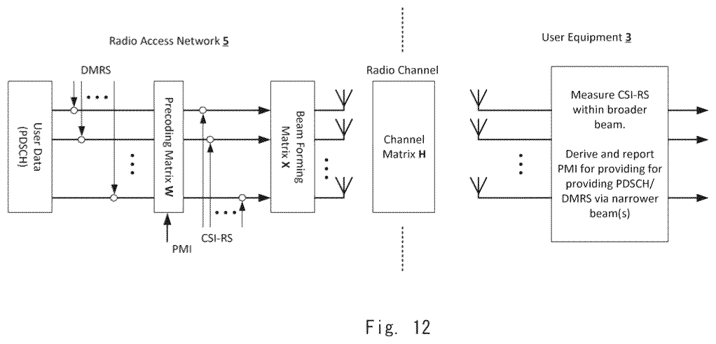

As illustrated in FIG. 12, the CSI-RS transmissions may be beamformed and all the CSI-RS antenna ports mapped to the same beam at a given timing (albeit different beams can be used at different times). Each CSI-antenna port may be mapped to a respective set of physical antenna elements. In this case, even though the CSI-RS is already beamformed, a PMI may be used to indicate a narrower pre-coded beam that can be formed using the CSI-RS antenna ports. Thus, the UE 3 measures the CSI-RS and identifies, from a PMI codebook, a set of precoding parameters (and hence an associated PMI) which, if applied to the CSI-RS transmissions in the current beam, would generate a narrower pre-coded beam towards the UE 3. The UE 3 reports this PMI to the base station 5 (e.g., in a CSI report including other relevant parameters such as CQI and/or RI) and the base station 5 can, if it decides to use the reported PMI, apply the precoding parameters appropriately to precode/beamform the DMRS and/or associated PDSCH based on the PMI indication. This example has particular relevance to frequency range 2 (FR2) and hence TDD that uses FR2.

On receipt of the PDSCH/DMRS, measurement of the DMRS can be performed in the usual way for estimation of the composite propagation channel (i.e., the propagation channel as modified by precoding/beamforming—e.g., multiplication by the precoding matrix W and beamforming precoding matrix X) and decoding of the PDSCH.

<Mapping from CSI-RS to CSI-RS Antenna Ports/Antenna Elements>

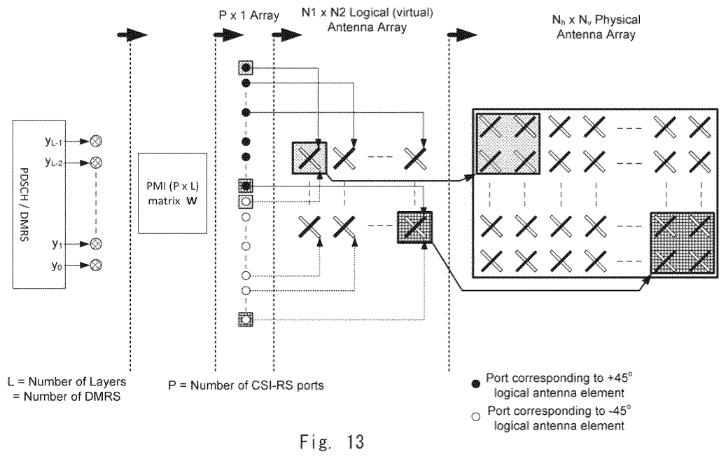

Referring to FIGS. 13 to 15, the communication system 1 provides a mapping between each CSI-RS antenna port and a corresponding logical antenna element of a logical antenna array. There are a number of different configurations that may be used for the logical antenna arrays. The mapping from the logical antenna elements to physical antenna elements depends on the specific implementation employed at the base station 5/UE 3 and is transparent to the operation of the base station 5/UE 3. This use of logical CSI-RS antenna ports in this way allows a reduction in the total number of CSI-RS ports which are used for transmission to improve radio resource usage (because each CSI-RS port has a respective radio resource overhead).

FIG. 13 illustrates an exemplary mapping between CSI-RS ports, logical antenna elements of a virtual antenna array, and physical antenna elements of a physical antenna array (single panel in this example). It will be appreciated that the illustration is simplified for clarity and not every mapping is shown.

As seen in FIG. 13 the logical antenna array has N1 logical cross-polar pairs in the horizontal direction and N2 logical cross-polar pairs in the vertical direction. Each logical cross-polar pair includes a +45° logical antenna element and a −45° logical antenna element. There is a CSI-RS antenna port corresponding to each logical antenna element and hence the total number, P, of CSI-RS antenna ports is equal to the total number of cross-polar pairs (N1×N2) multiplied by the number of antenna elements per cross-polar pair (2)—i.e., P=2×N1×N2.

Each logical cross-polar pair (and hence its associated logical antenna elements) is mapped to a respective group of physical cross-polar pairs (and hence and associated group of physical antenna elements). In the example there are four physical antenna elements/cross-polar pairs mapped to each logical antenna element/cross-polar pair (although it will be appreciated that any suitable mapping may be used).

Data and DMRS transmitted via an appropriate number, L, of transmission layers (where L may be greater than or equal to one) is precoded via an appropriate precoding matrix for transmission via each of the CSI-RS ports.

As each CSI-RS port is mapped to multiple antenna elements it is possible to perform beamforming in respect of signals transmitted via the CSI-RS antenna ports. For example, a base station 5 (e.g., that operates in FR 2) may decide to use beamforming for each CSI-RS resource transmission (to increase coverage). In this case, the base station may configure multiple CSI-RS resources (one for each beam) where each CSI-RS resource has a plurality (N) of CSI-RS ports. This is similar to the scenario illustrated in FIG. 12.

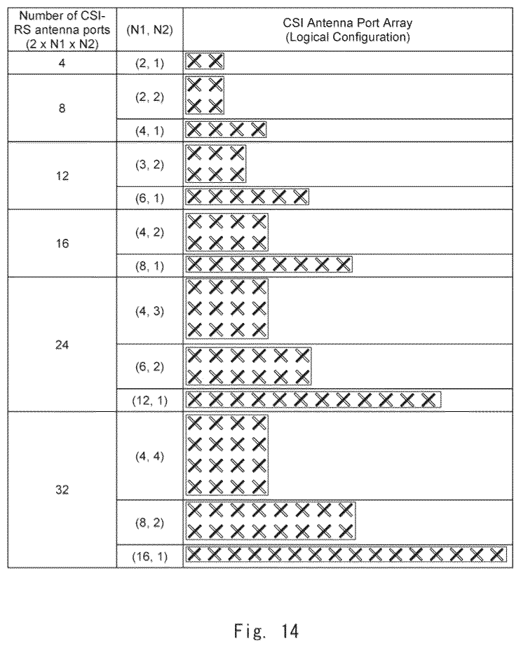

It will be appreciated that while the illustration shows an array in which there is a two-dimensional array of at least six logical cross-polar pairs (twelve logical antenna elements) the array may be one dimensional (e.g., N2=1) and there may be fewer logical cross-polar pairs/antenna elements. For example, if there is no specific requirement to have multiple beams in a vertical direction (e.g., in rural area), then the base station may choose to map each CSI-RS antenna port to a logical antenna element corresponding to all the physical antenna elements in a column of a physical antenna array. In this case N2 would equal 1 and beamforming may only occur in the horizontal direction. FIG. 14 illustrates, for example, a number of different CSI-RS to logical antenna array configurations for a single panel antenna.

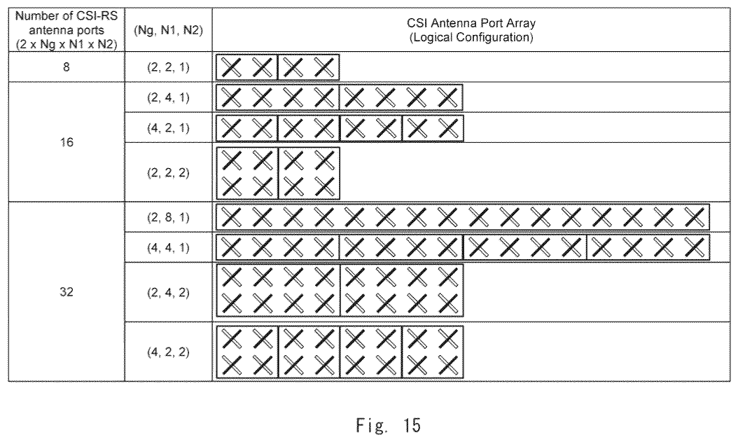

It will also be appreciated that for antennas having multiple antenna panels additional CSI-RS ports are configurable. FIG. 15 illustrates, for example, a number of different CSI-RS to logical antenna array configurations for multi-panel antennas (where Ng is the number of antenna panels). For multiple antenna panels, each the antenna elements of each panel are mapped to a respective N1×N2 array of logical cross-polar pairs of antenna elements. Accordingly, for multi-port antennas, the total number of CSI-RS ports is given by 2×Ng×N1×N2 (where Ng, N1 and N2 are configurable by the network).

It will be appreciated that, in the examples of FIGS. 14 and 15 higher values of N1 imply more beams can be created in horizontal direction whereas higher values of N2 imply more beams can be created in vertical direction.

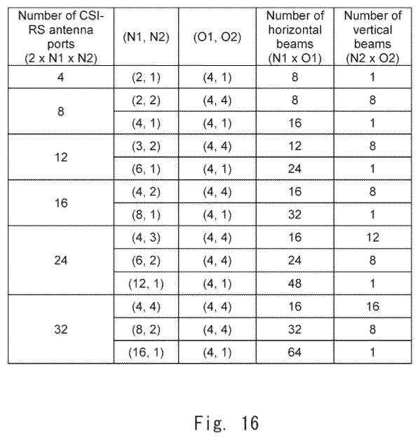

FIG. 16 illustrates, by way of example, the number of horizontal beams and vertical beams that may be configured per CSI-RS resource for each configuration listed in FIG. 14. As seen in FIG. 16, the possible number of pre-coded beams per CSI-RS resource is dependent on N1 and N2 (which are based on the logical antenna configuration as described previously) and O1 and O2 are oversampling parameters indicated in the configuration. Specifically, O1 and O2 effectively indicate the number of angular sweeping steps of a pre-coded beam. O1 corresponds to sweeping steps in the horizontal direction whereas O2 corresponds to sweeping steps in vertical direction. Accordingly, the higher the oversampling parameter (O1, O2) is the smaller the angular beam sweeping step. The number of possible pre-coded beams per CSI-RS resource in the horizontal direction is therefore given by N1×O1 and the number of pre-coded beams in the vertical direction is given by N2×O2.

### <Precoder Matrix Indication (PMI)>

As described above, the PMI may be used by the UE 3 to report a preferred precoding for PDSCH transmissions. The PMI (or at least partial PMI) may be sent as feedback to the base station 5 in either closed loop or semi-open loop transmission schemes. The PMI can indicate precoding for only MIMO (typically for smaller antenna configurations) or for both MIMO and beamforming (typically for larger antenna configurations). The base station 5 does not have to apply the precoding indicated by the PMI and does not need to inform the UE 3 of the actual precoding applied. Nevertheless, the UE 3 can determine the combined effect of the actual precoding and the propagation channel based on measurements of the DMRS, which are precoded in the same way as the PDSCH, and thus decode the PDSCH.

A number of precoder matrix types that may be predefined based on a set of corresponding logical antenna configurations (e.g., logical antenna configurations as illustrated in FIGS. 14 and 15). These may, for example, be precoder matrices specified by a relevant standard (e.g., 3GPP TS 38.214).

The precoder matrices are categorised into four different codebook categories: type 1, single panel; type 1, multi-panel; type 2, single panel; type 2, port selection. Type 1 codebooks generally provide relative course information, whereas Type 2 codebooks provide more detailed information albeit at the expense of signalling overhead.

For codebook type 1, the precoder matrices may, by way of illustration, have a structure similar to one of the two following general formats (with the occasional exception):

$${W}_{parameters}^{( no of layers )} = [ \begin{matrix}{v}_{1} & {v}_{2} & … & {v}_{n} \\ {φ}_{1} {v}_{1} & {φ}_{2} {v}_{2} & … & {φ}_{n} {v}_{n}\end{matrix} ] , \qquad [ Equation 4 ]$$

$$and$$

$${W}_{parameters}^{( no of layers )} = [ \begin{matrix}{v}_{1} & {v}_{2} & … & {v}_{n} \\ {θ}_{1} {v}_{1} & {θ}_{2} {v}_{2} & … & {θ}_{n} {φ}_{n} {v}_{n} \\ {φ}_{1} {v}_{1} & {φ}_{2} {v}_{2} & … & {φ}_{n} {v}_{n} \\ {φ}_{1} {θ}_{1} {v}_{1} & {φ}_{2} {θ}_{2} {v}_{2} & … & {φ}_{n} {θ}_{n} {v}_{n}\end{matrix} ] . \qquad [ Equation 5 ]$$

In each case the number of rows corresponds to the number of CSI-RS ports (P) and the number of columns to the number of transmission layers (L).

v₁, v₂, . . . vₙ effectively define the pre-coded beam weights to be applied to CSI-RS ports. The specific codebook that is configured effectively determines how many unique possible values for vₙ can be present per precoding matrix (1 or 2 or 3).

θₙ indicates a weight corresponding to each of the two possible polarizations and, in most cases, the different values of θₙ in a precoding matrix will differ only in respect of their sign (+/−).

φₙ is an additional weight term added to account for a non-uniform multi-antenna panel scenario (so that pre-coded beams from the different panels are added constructively e.g., when a gap between adjacent panels results in an inter-panel spacing between antenna elements being different to the intra-panel spacing).

For codebook type 1, for 1 or 2 transmission layers, two different codebook modes may be used. Using codebook mode 1 allows for higher granularity in horizontal and vertical directions for wideband, whereas codebook mode 2 has higher resolution for subbands.

Each precoding matrix W can be understood to corresponds to the product of two matrices (W=W₁W₂). The first matrix W₁ includes a set of beam weights (i.e., (vₙ)) and can be understood to represent the long-term channel characteristics (wideband), while W₂ is a vector that captures the short-term channel characteristics (subband). W₁ can be understood to contain multiple beam directions, whereas the W₂ matrix can be understood to select a subset of beam directions (for codebook mode 2) and/or to perform phase shifting (for codebook modes 1 and 2).

It will be appreciated that for a given scenario different transmission layers may be accomplished by using different beams and/or polarizations. For example, a signal received via different beams, or via different polarizations, may be configured to have uncorrelated (orthogonal) propagation channels.

The PMI reporting may be divided into two stages. The first stage provides feedback (referred to as i1) to the base station 5 representing wideband information that does not change rapidly with time whereas the second stage provides feedback (referred to as i2) to the base station 5 representing subband information which changes rapidly. The i1 part of PMI effectively indicates one or more beam weight values (vₙ) in the precoding matrix. The i1 part of the PMI is reported for a wide band (i.e., a single measurement for all CSI-RS subbands) whereas the i2 part of the PMI can be reported per subband (based on the CSI report configuration as described previously).

In some cases (e.g., semi-open loop transmission schemes) the UE 3 may be configured to report only i1. For example, the base station 5 can configure the UE 3 to provide a CSI report (e.g., using a CSI-ReportConfig IE) that provides partial precoding information (e.g., i1 but not i2) by setting the reporting quantity parameter appropriately. The UE 3 may, for example, be configured to report RI, i1 and CQI for one or more associated CRIs, by setting the reporting quantity parameter appropriately (e.g., to cri-RI-i1-CQI) or to report RI, i1 without CQI for one or more associated CRIs, by setting the reporting quantity parameter appropriately (e.g., to cri-RI-i1).

By way of illustration, the exemplary case of 2-layer PMI feedback for a single panel type 1 codebook, using codebook mode 1, will now be considered. In this case the precoding matrix is specified as:

$${W}_{l , {l}^{′} , m , {m}^{′} , n}^{( 2 )} = \frac{1}{\sqrt{2 {P}_{CSI - RS}}} [ \begin{matrix}{v}_{l , m} & {v}_{{l}^{′} , {m}^{′}} \\ {φ}_{n} {v}_{l , m} & - {φ}_{n} {v}_{{l}^{′} , {m}^{′}}\end{matrix} ] \qquad [ Equation 6 ]$$

where PCSI-RS is the number of CSI-RS antenna ports and

$${φ}_{n} = {e}^{j π n / 2} .$$

The UE reports i1 and i2 where i1=[i_{1,1}, i_{1,2}, i_{1,3}]. i_{1,1} effectively indicates the index of the beam to be used in the horizontal direction, i_{1,2} effectively indicates the index of the beam to be used in the vertical direction, i_{1,3} effectively indicates a second beam (with respect to an offset to the first beam) that should be formed for PDSCH transmission (multiple beams can provide independent orthogonal channels), and i2 indicates the weight used for a second polarization.

The translation from the beam indices to actual beam weights in the case of 5G is defined in the relevant standards (e.g., 3GPP TS 38.214).

i1 and i2 are mapped to W based on the following prespecified table:

TABLE 2
codebookMode = 1

| i_{1,1} | i_{1,2} | i₂ | |
|---|---|---|---|
| 0, 1, . . . , N₁O₁ − 1 | 0, 1, . . . , N₂O₂ − 1 | 0, 1 | Wᵢ_{_{1,1}}_{,i}_{_{1,1}}₊ₖ_{₁}_{,i}_{_{1,2}}_{,i}_{_{1,2}}₊ₖ_{₂}_{,i}_{₂}⁽²⁾ |

k1 and k2 are determined based on i_{1,3} based on following prespecified table:

TABLE 3

| | N₁ > N₂ > 1 | | N₁ = N₂ | | N₁ = 2, N₂ = 1 | | N₁ > 2, N₂ = 1 | |
|---|---|---|---|---|---|---|---|---|
| i_{1, 3} | k₁ | k₂ | k₁ | k₂ | k₁ | k₂ | k₁ | k₂ |
| 0 | 0 | 0 | 0 | 0 | 0 | 0 | 0 | 0 |
| 1 | O₁ | 0 | O₁ | 0 | O₁ | 0 | O₁ | 0 |
| 2 | 0 | O₂ | 0 | O₂ | | | 2O₁ | 0 |
| 3 | 2O₁ | 0 | O₁ | O₂ | | | 3O₁ | 0 |

The precoder matrix defined by Equation 6 thus becomes:

$$\frac{1}{\sqrt{2 {P}_{CSI - RS}}} [ \begin{matrix}{v}_{{i}_{1 , 1} , {i}_{1 , 2}} & {v}_{{i}_{1 , 1} + {k}_{1} , {i}_{1 , 2} + {k}_{2}} \\ {e}^{j π {i}_{2} / 2} {v}_{{i}_{1 , 1} , {i}_{1 , 2}} & - {e}^{j π {i}_{2} / 2} {v}_{{i}_{1 , 1} + {k}_{1} , {i}_{1 , 2} + {k}_{2}}\end{matrix} ] .$$

The first column of the matrix effectively corresponds to a first transmission layer for transmissions via a first beam from a first CSI-RS port and is defined by i_{1,1} and i_{1,2}. The second column of the matrix effectively corresponds to a second transmission layer for transmissions via a second beam from a second CSI-RS port and is defined by i_{1,1}+k₁ and i_{1,2}+k₂.

For each rank (number of transmission layers), the UE 3 can attempt to determine the parameters for i1 and i2, based on CSI-RS reception, which result in the best performance and hence indicate the values to the base station.

The base station 5 can configure restrictions on the values reported. For example, the base station 5 can indicate using a bitmap (e.g., in codebook configuration IE) which values of i_{1,1} and i_{1,2} are restricted. Similarly, the base station 5 can indicate using a bitmap (e.g., in codebook configuration IE) which rank values are restricted.

### <Uplink Power Control>

In the communication system 1, UL communication by the UE 3 (e.g., PUSCH, PUCCH, SRS, and PRACH transmissions) is subject to power control (for example as defined in 3GPP TS 38.213 for a 5G communication system). The communication system supports multiple power states for both PUSCH transmission power and for PUCCH transmission power (e.g., to support multiple transmission reception points per cell).

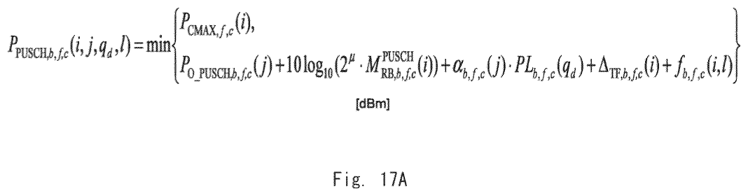

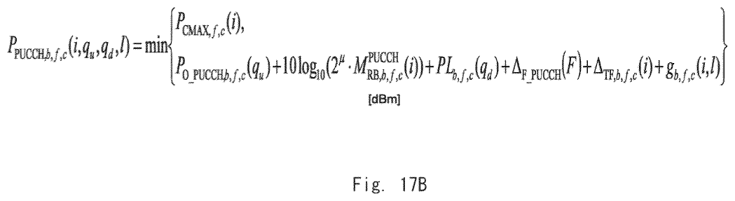

For example, in respect of the PUSCH, if the UE 3 transmits a PUSCH on an active UL BWP b of carrier f of serving cell c using a parameter set configuration with index j and PUSCH power control adjustment state with index 1, then the UE 3 determines the PUSCH transmission power P_{PUSCH,b,f,c} (i,j,q_{d},1) in PUSCH transmission occasion i based on the equation shown in FIG. 17A in which:
P_{CMAX, f,c} (i) is a UE configured maximum output power for carrier f of serving cell c in PUSCH transmission occasion i;
P_{O_PUSCH,b,f,c} (j) is a parameter composed of the sum of two components
P_{O_NOMINAL_PUSCH,f,c} (j) and a component P_{O_UE_PUSCH, b,f,c} (j) where j∈{0, 1, . . . , J−1}—a UE 3 can effectively be configured with any of multiple values for P_{O_PUSCH,b,f,c} (j). For example one of the values may be indicated by a scheduling request indicator (SRI) field in a DCI for PUSCH;

$${M}_{RB , b , f , c}^{PUSCH} ( i )$$

is the bandwidth of the PUSCH resource assignment expressed in number of resource blocks for PUSCH transmission occasion i on active UL BWP b of carrier f of serving cell c and u is an SCS configuration;
α_{b,f,c} (j) is a parameter that is generally configured by the network (or equal to 1 where it is not configured by the network and j=0);
PL_{b,f,c} (q_{d}) is a downlink pathloss estimate in dB calculated by the UE using reference signal (RS) index q_{d} for the active DL BWP, as described in Clause 12, of carrier f of serving cell c-path loss is therefore computed based on a RS. The UE 3 can be configured with multiple RS indices for determining path loss and one of the RS indices may be indicated by an SRI field in a DCI for PUSCH;
Δ_{TF,b,f,c} (i) is a PUSCH transmission power adjustment component on active UL BWP b of carrier f of primary cell c; and
f_{b,f,c} (i,1) is a current PUSCH power control adjustment state for the active UL BWP b of carrier f of serving cell c in PUSCH transmission occasion i—this contains a component from a transmit power control (TPC) command. Two states are typically possible for this and the state value to use is indicated by an SRI field in a DCI for PUSCH.

In respect of the PUCCH, if the UE 3 transmits a PUCCH on active UL BWP b of carrier f in the primary cell c using PUCCH power control adjustment state with index 1, the UE determines the PUCCH transmission power P_{PUCCH,b,f,c} (i,qᵤ,q_{d},1) in PUCCH transmission occasion i based on the equation shown in FIG. 17B in which:
P_{CMAX, f,c} (i) is a UE configured maximum output power for carrier f of serving cell c in PUCCH transmission occasion i;
P_{O_PUCCH,b,f,c} (qᵤ) is a parameter composed of the sum of a component P_{O_NOMINAL_PUCCH} (which may be network configured or 0 if not network configured), for carrier f of primary cell c and another component P_{O_UE_PUCCH} (qᵤ) (which may be network configured or 0 if not network configured) for active UL BWP b of carrier f of primary cell c, where 0≤qᵤ<Qᵤ. Qᵤ is a configured size for a set of P_{O_UE_PUCCH} values—the UE 3 can be configured with any of multiple values for P_{O_PUCCH,b,f,c} (qᵤ) and one of the values may be indicated by a PUCCH spatial relation MAC CE;

The UE 3 may be provided with PUCCH spatial relation information (e.g., a PUCCH-SpatialRelationInfo IE) which includes a set of potential values for P_{O_UE_PUCCH} (qᵤ) associated with a PUCCH spatial relation information identifier (e.g., a pucch-SpatialRelationInfoId IE). The UE 3 is able to map an index corresponding to the PUCCH spatial relation information identifier to the corresponding value for P_{O_UE_PUCCH} (qᵤ).

$${M}_{RB , b , f , c}^{PUSCH} ( i )$$

is a bandwidth of the PUCCH resource assignment expressed in number of resource blocks for PUCCH transmission occasion i on active UL BWP b of carrier f of serving cell c and u is a SCS configuration;
PL_{b,f,c} (q_{d}) is a downlink pathloss estimate in dB calculated by the UE using RS resource index q_{d}-path loss is therefore computed based on a RS. The UE 3 can be configured with multiple RS indices for determining path loss and one of the RS indices may be indicated by a PUCCH spatial relation MAC CE;
Δ_{F_PUCCH} (F) is a parameter that is either configured based on the PUCCH format or is zero;
Δ_{TF,b,f,c} (i) is a PUCCH transmission power adjustment component on active UL BWP b of carrier f of primary cell c; and
g_{b,f,c} (i,1) is a current PUCCH power control adjustment state 1 for active UL BWP b of carrier f of serving cell c and the PUCCH transmission occasion—this contains a component from a transmit power control (TPC) command. Two states are typically possible for this and the state value to use is indicated b by a PUCCH spatial relation MAC CE.

Like the PUCCH and PUSCH SRS can be configured with multiple states for power control.

PRACH power is determined purely based on power ramp up procedure (e.g., as defined in 3GPP TS 38.321) and path loss is calculated based on the SSB which is used for random access channel (RACH) resource selection. A power scaling factor has been defined in 3GPP TS 38.321 which is mainly applicable to a two-step RACH or RACH prioritization.

<Segregation of Different Antenna Elements into UL and DL>

Beneficially, in the communication system 1, the base station 5 is configured for, in the same one or more SBFD slots (or symbols), transmission to a UE 3 in the downlink via a first set (or group) of antenna elements, and for reception from another UE 3 in the uplink via a second set (or group) of antenna elements that is spatially separated from the first set of antenna elements. This spatial separation between the antenna elements used for UL and DL can result in lower interference being observed during UL reception at the base station 5.

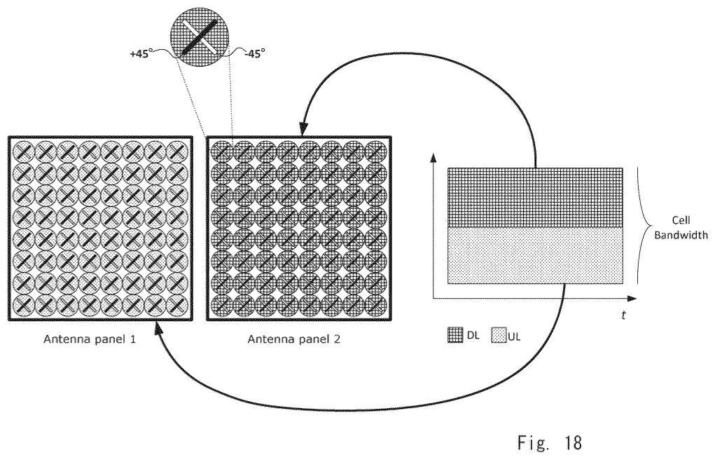

Referring to FIG. 18 which is a simplified illustration of an antenna panel configuration for full duplex communication in the communication system 1, the spatial separation is achievable by using a different antenna panel for DL communication than is used for UL communication.

During legacy TDD slots/symbols (e.g., dedicated UL only slots/symbols or dedicated DL only slots/symbols) antenna elements 712 of both the first and second sets of antenna elements can still be used for the same transmission direction (e.g., reception in UL/transmission in downlink).

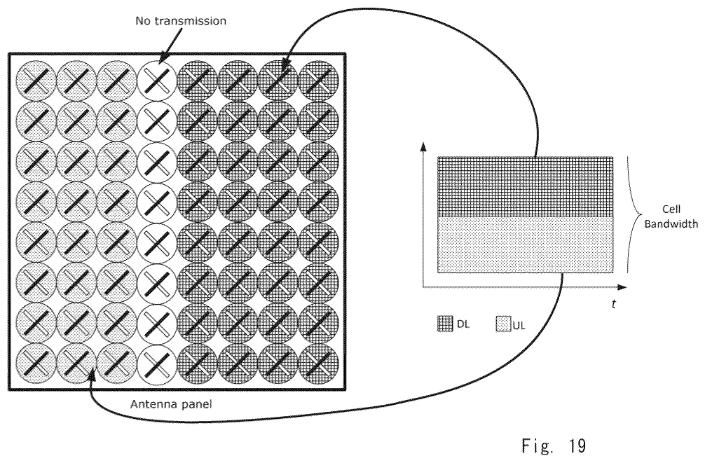

As described above, the base station 5 (or another similar base station 5 of the communication system 1) may have a single panel. For a base station 5 that communicates via a single antenna panel, the base station 5 may, beneficially, be configured for in panel segregation of antenna elements. One such arrangement is illustrated in FIG. 19, which is a simplified illustration of another antenna panel configuration for full duplex communication in the communication system 1.

As seen in FIG. 19, the base station 5 is configured for, in the same one or more SBFD slots (or symbols), transmission to a UE 3 in the downlink via a first set (or group) of antenna elements within a first region of the antenna panel, and for reception from another UE 3 in the uplink via a second set (or group) within a first region of the antenna panel. Spatial separation between the antenna elements of the first set and the antenna elements of the second set may be further enhanced (e.g. beyond the half signal wavelength typically provided between antenna elements) in this example by configuring a third set of antenna elements for no transmission. This enhanced spatial separation between the antenna elements between the UL group and the DL group can beneficially help to reduce interference but, it will be appreciated, is not essential for successful full duplex operation.

It will be appreciated that the number of antenna elements in each group (UL/DL) can vary depending on requirements. For example, the number of antenna elements may depend on DL/UL subband size and/or the UL/DL coverage requirement.

It will be appreciated, however, that segregation of the antenna elements as described in relation to FIG. 18 and/or FIG. 19 will effectively reduce the number of operating antenna elements for DL and for UL. Reducing the number of DL antenna elements in this way effectively reduces the number of CSI-RS ports and can result in different values of N1 and N2 defining the logical downlink antenna array. This, in turn, could lead to change in the codebook parameters required for precoding/beamforming and have an impact on a number of related procedures.

As described in more detail below, the communication system 5 beneficially employs one or more mechanisms to alleviate the impact of the reduced number of antenna elements. These mechanisms include, for example, mechanisms to mitigate the impact in the context of: UE measurement procedures; provision of DL and/or UL transmission parameters (e.g., codebook parameters, ports etc.) for data transmission/reception during SBFD slots; a potential reduction in UL decoding performance arising from the reduced number of antenna elements used during SBFD slots.

These mechanisms are introduced and described in more detail below. It will be appreciated that while several beneficial mechanisms are described the communication system need not employ all of them to derive a technical benefit. Moreover, it will be appreciated that while some of the mechanisms involve a technique that may be employed as an alternative to another described techniques to achieve a similar technical benefit such techniques are not mutually exclusive. For example, the communication system may implement a plurality such ‘alternative’ techniques (e.g., for use at different times or in different circumstances) to increase the flexibility of the communication system.

### (UE Measurement Procedures)

Due to the change in the number of antenna elements there is the potential for there to be a change in transmission characteristics (e.g., beam pattern/number of ports/antenna gain, etc.) of different reference signals (CSI-RS and/or SSB), between SBFD slots/symbols and legacy TDD DL slots/symbols.

Accordingly, where different transmission characteristics are applicable for SBFD and legacy TDD slots, the communication system 1 may implement one or more techniques for alleviating the impact of this in respect of measurements of CSI-RS and/or SSBs.

### <Channel State Information Reference Signal (CSI-RS) Measurement>

The presence of a different number of ports/frequency resources/transmission power in SBFD slots/symbols has the potential to lead to unreliable CSI-RS measurement results from the UE 3. Accordingly, the communication system 1 can employ one or more mechanisms by which for network can indicate how CSI-RS is being transmitted in the context of SBFD.

It will be appreciated that the techniques described are particularly applicable to dynamic SBFD slot scheduling. For RRC configured SBFD occurrence, the network could potentially avoid the issue by using appropriate RRC configuration of CSI-RS resources.

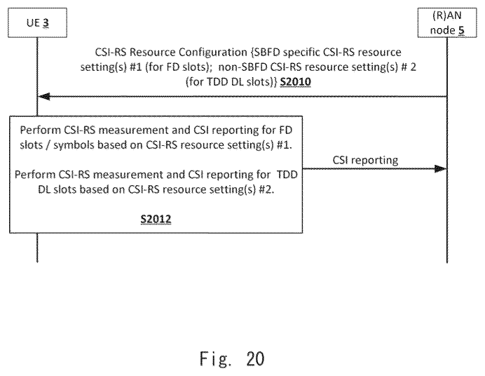

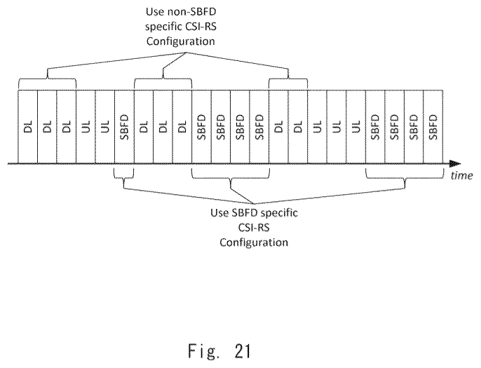

FIG. 20 is a simplified sequence diagram illustrating a procedure in which the base station 5 configures different CSI-RS settings for CSI-RS transmission during SBFD slots/symbols than for CSI-RS transmission during (legacy) TDD DL slots/symbols. FIG. 21 illustrates an exemplary implementation of the procedure of FIG. 20.

As seen in FIG. 20, when the base station 5 configures different CSI-RS settings for CSI-RS transmission during SBFD slots/symbols than for CSI-RS transmission during (legacy) TDD DL slots/symbols, the base station 5 provides CSI-RS configuration information (at S2010) which includes one or more different CSI-RS resource settings for transmission of CSI-RS during an SBFD slot/symbol than for transmission of CSI-RS during (legacy) TDD slots.

When (at S2012) the UE 3 performs CSI-RS measurement and reporting, the UE 3 can perform the CSI-RS measurement and reporting based on one or more SBFD specific CSI-RS resource settings for SBFD slots/symbols and can perform the CSI-RS measurement and reporting based on one or more TDD specific CSI-RS resource settings for other (legacy) TDD slots/symbols.

One or more different CSI-RS resource settings for SBFD slots/symbols than for (legacy) TDD DL slots or symbols may, for example, include a different power value that is applicable to a CSI-RS resource transmission during an SBFD slot/symbol than is applicable to a CSI-RS resource transmission during a TDD DL slot/symbol.

One or more SBFD specific CSI-RS resource settings for SBFD slots/symbols may indicate which CSI-RS ports are valid (or invalid) for SBFD slots. This may, for example, be indicated as a configuration, per CSI-RS resource, indicating: a list, range, and/or mask of antenna port numbers; and/or a list, range, and/or mask of antenna panels.

One or more SBFD specific CSI-RS resource settings for SBFD slots/symbols may indicate specific frequency resources for CSI-RS transmission during SBFD slots.

For example, one or more SBFD specific CSI-RS resource settings may indicate a subset of frequency resources (among one or more CSI-RS resource configurations) which are punctured (or not punctured) during SBFD slots/symbols.

Alternatively or additionally, one or more SBFD specific CSI-RS resource settings may indicate a new frequency resource configuration applicable for CSI-RS during SBFD (this may be within a CSI-RS configuration or may be derived from another, separate, RRC configuration for SBFD). The UE 3 can determine the CSI-RS sequence based on normal procedures.

In another technique, for aperiodic CSI-RS, the network can indicate, within DCI, which CSI-RS parameters are applicable.

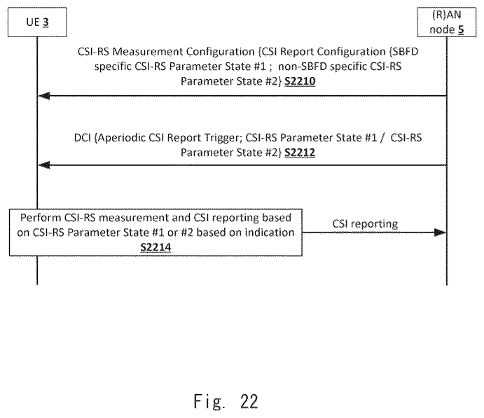

FIG. 22 is a simplified sequence diagram illustrating a procedure in which the base station 5 configures two different parameter states (one to be used for SBFD and the other for (legacy) TDD DL slots) for the same CSI report and/or reference signal.

As seen in FIG. 22, the base station 5 configures, at S2210, the UE 3 with two different CSI-RS parameter states (each representing a different respective set of parameters) for a particular CSI reporting configuration (and associated CSI-RS resource configuration). The parameter states include an SBFD specific CSI-RS parameter state, and a TDD specific CSI-RS parameter state. When the network transmits a trigger for triggering an aperiodic CSI report (using DCI), as indicated at S2212, it also indicates which parameter state should be used for the given CSI report. The indication can be explicit indicating which CSI parameters to use or can be implicit (e.g., derived from an SBFD indication within DCI).

When (at S2214) the UE 3 performs CSI-RS measurement and reporting, the UE 3 can perform the CSI-RS measurement and reporting based on the set of parameters corresponding to the indicated parameter state.

It will be appreciated that this is different from use of an aperiodic trigger DCI in which the network indicates, out of a plurality of CSI reporting configurations, which configuration to use for reporting. In this case, the different parameter states (and associated parameter sets) are for measuring and reporting the same CSI-RS configuration.

In another technique the network can indicate a set of time occasions for which CSI-RS resources are not transmitted.

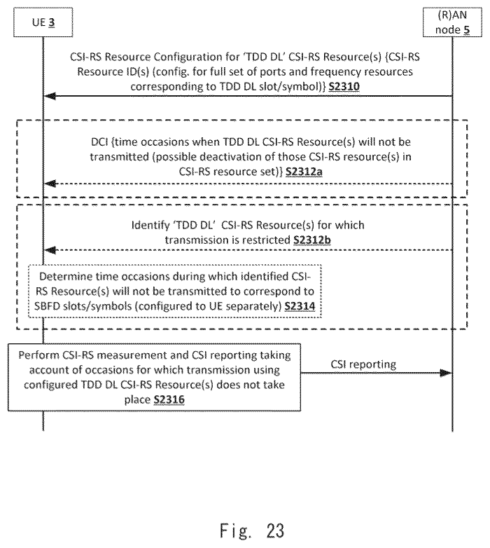

FIG. 23 is a simplified sequence diagram illustrating a procedure in which the base station 5 configures at least one CSI-RS resource with full set of ports and frequency resources corresponding to a (legacy) TDD DL slot/symbol.

In FIG. 23 the CSI-RS resources configured in this way for a (legacy) TDD DL slot/symbol are referred to as TDD DL CSI-RS resources for clarity but it will be appreciated that they may not be distinguished from other CSI-RS resources in the CSI-RS resource configuration.

As seen in FIG. 23, the base station 5 provides CSI-RS configuration information at S2310). The base station 5 then indicates to the UE 3 that the CSI-RS resource will not be used for transmission in a specific set of time occasions.

As indicated at S2312a the base station 5 may indicate the time occasions as a part of a DCI indication (e.g., be means of a pre-emption indication or the like). The DCI may indicate one or more CSI-RS resources in a given CSI resource set, to be deactivated during the set of time occasions.

As indicated at S2312b the base station 5 may indicate (e.g., via RRC configuration signalling/MAC CE/DCI or the like) for which CSI-RS resource transmission is restricted. In this case the UE 3 can determine (as seen at S2314) the associated time occasions based on SBFD time occasions signalling (i.e. the UE 3 can determine that CSI-RS will not be transmitted using one or more CSI-RS resources during a previously configured SBFD slot/symbol).

The UE 3 can then perform CSI-RS measurement and CSI reporting (at S2316) taking account of occasions for which transmission using one or more configured CSI-RS resources does not take place.

It is possible that the UE 3 may be configured with a plurality of different SBFD configuration (e.g., with different SBFD slot/symbol patterns/timings). In this case the base station 5 can also indicate, for each CSI-RS resource for which transmission is restricted, that the restriction is for a specific SBFD configuration.

It will be appreciated that the base station 5 may also configure two different sets of CSI-RS resources-a first set of CSI-RS resources that will not be used for transmission during SBFD slots and a second set of CSI-RS resources that are only used for transmission during SBFD slots.

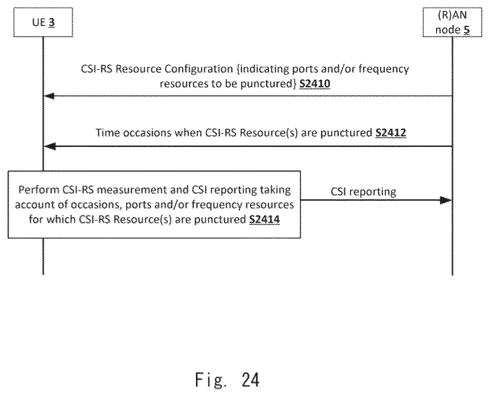

FIG. 24 is a simplified sequence diagram illustrating a procedure for implementing another technique in which the network can indicate a set of time occasions CSI-RS a set of time occasions for which CSI-RS resources are punctured.

In FIG. 24, when the base station 5 configures (at S2410) at least one CSI-RS resource, the base station 5 can indicate one or more ports and/or frequency resources that are to be punctured during indicated time occasions. It will be appreciated that, alternatively or additionally, the UE 3 might determine one or more ports and/or frequency resources that are to be punctured during indicated time occasions based on an SBFD configuration.

As seen in FIG. 24, the base station 5 indicates (at S2412) the time occasions during which one or more CSI resources are punctured using appropriate signalling (e.g., signalling similar to that described for indicating the time occasions, described with reference to FIG. 23, such as DCI, RRC configuration, MAC CE signalling or the like).

The UE 3 can then perform CSI-RS measurement and CSI reporting (at S2414) taking account of the occasions, and the ports and/or frequency resources, for which transmission using one or more configured CSI-RS resources is punctured.

It can be seen that this option is similar to that described with reference to FIG. 21 where a subset of frequency resources which are punctured (or not punctured) during SBFD slots/symbols are indicated. However, in this case the puncturing need not be explicitly associated with SBFD slots and no new configuration for SBFD is provided.

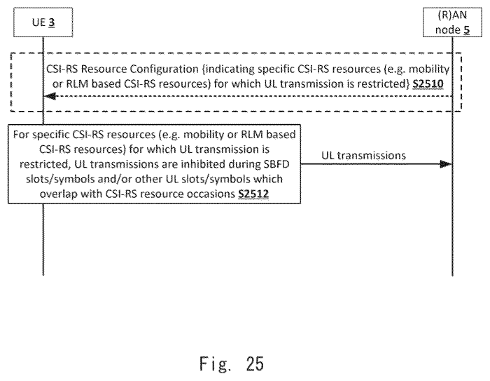

FIG. 25 is a simplified sequence diagram illustrating a procedure for implementing another technique in which for certain CSI-RS resources (e.g. mobility and/or radio link monitoring (RLM) based CSI-RS resources) the UE is inhibited from performing UL transmissions during SBFD or UL symbols/slots which overlap with given CSI-RS resource occasions.

In FIG. 25, the base station 5 may configure (at S2510) at least one CSI-RS resource (e.g. mobility or RLM based CSI-RS resources) for which UL transmission is restricted. It will be appreciated that, alternatively or additionally, the UE 3 may be preconfigured with specific CSI-RS resource types (e.g. mobility or RLM based CSI-RS resources) for which UL transmission is restricted.

As indicated at S2512, for these specific CSI-RS resources (e.g. mobility or RLM based CSI-RS resources) for which UL transmission is restricted, the UE 3 does not perform UL transmissions during SBFD slots/symbols and/or other UL slots/symbols which overlap with the corresponding configured CSI-RS resource occasions.

Another potential issue that could arise, regardless of whether the above procedures are implemented, is that the UE 3 may nevertheless acquire incorrect or partial CSI measurements during SBFD slots. This may occur, for example, when a single CSI report may be associated with CSI-RS transmitted during both SBFD and during legacy DL. If the UE 3 computes the CSI based on these measurements, then it could lead to an inaccurate result (e.g., the CQI may be underestimated).

As described above CSI reporting can be subject to a time restriction configured in the CSI reporting configuration. When the time restriction is configured, the UE 3 derives the measurements for computing CSI values based on the last measured CSI-RS occasion associated with the CSI report. Accordingly, when the time restriction is configured, the CSI report has the potential to be based only on measurements for CSI resources made in an SBFD slot/symbol and hence some CSI report information (e.g. a subset of ports or subset of frequency resources for which measurement is required for configured CSI reporting may not be measured by the UE 3).

When the time restriction is not configured, the CSI report could be based on combined measurements for CSI resources made both during an SBFD slot/symbol and during a legacy TDD DL slot/symbol. In this scenario the CSI report may also be based on incorrect/partial CSI measurement information.

Beneficially, the communication system 1 may employ one or more techniques for enhancing the CSI computation procedure to take account of situations in which CSI-RS may be measured within SBFD slots/symbols and/or within legacy TDD DL slots.

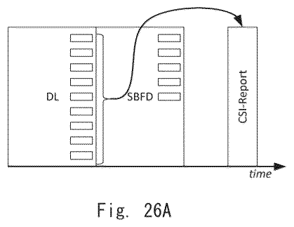

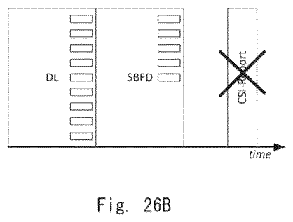

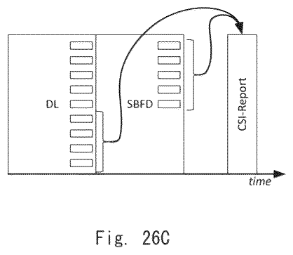

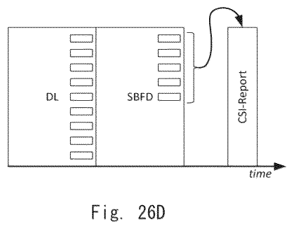

FIGS. 26A to 26D each illustrate a different possible technique that may be employed for CSI reporting when the time restriction is configured, and the last CSI-RS was measured during an SBFD slot/symbol.

FIG. 26A illustrates a technique in which, for a CSI report which requires the UE 3 to compute CSI based on measurements over ports and/or a frequency region for which transmissions are not received during SBFD slots, the UE 3 discards/ignores those CSI-RS occasions that coincide with SBFD slots for CSI reporting purposes. Instead, the UE 3 uses the CSI-RS measurement performed during the preceding legacy TDD DL slot (i.e. when all the ports and frequency region of CSI-RS resource are available).

FIG. 26B illustrates a technique in which, for a CSI report which requires the UE 3 to compute CSI based on measurements over ports and/or a frequency region for which transmissions are not received during SBFD slots, the UE 3 does not perform CSI reporting for that CSI-RS occasion.

FIG. 26C illustrates a technique in which, for a CSI report which requires the UE 3 to compute CSI based on measurements over ports and/or a frequency region for which transmissions are not received during SBFD slots, the UE 3 uses the measurements, for the ports and/or a frequency region for which transmissions are not received during SBFD slots, from the previous set of CSI-RS measurements performed during an earlier legacy TDD DL slot. The UE 3 uses these measurements, in combination with the measurements made during the SBFD slot (for the ports and/or a frequency region for which transmissions can be received during SBFD slots) when compiling the CSI report.

FIG. 26D illustrates a technique in which the UE 3 computes the CSI report based on the last CSI-RS occasion during an SBFD slot regardless of any ports and/or a frequency region for which transmissions are not received during SBFD slots. In this case, the base station 5 derives the required CSI information based both the CSI report received for this CSI-RS occasion, and a CSI report received for the previous valid CSI-RS occasion.

In the technique illustrated in FIG. 26D, the CSI report may be compiled based on measurements for a reduced number of ports using one of the following derivation methods.

In a first method for CSI derivation based on a reduced number of ports, the UE 3 derives the CSI based on an assumed smaller number of ports for CSI computation. For example, the PMI indication may correspond to a lower number of ports than would otherwise be the case.

In a second method for CSI derivation based on a reduced number of ports, the UE 3 derives the CSI based on an assumption that all the ports are available. The PMI is determined, in part, based on CSI reception using the available number of ports. For the part of the PMI which cannot be determined in this way because it is dependent on the ports for which transmissions are not received, the UE chooses either random values or previously reported values (if available).

In the technique illustrated in FIG. 26D, the CSI report may be compiled based on measurements for a reduced number of frequency resources using one of the following derivation methods.

In a first method for CSI derivation based on a reduced number of frequency resources the UE 3 simply does not compute and report CSI (PMI and/or CQI) for one or more frequency resources for which CSI-RS are not transmitted during SBFD slots.

In a second method for CSI derivation based on a reduced number of frequency resources the UE 3 reports random values, or one of the previous reported values, for CQI and/or PMI for subbands where CSI-RS are not transmitted during SBFD.

In a third method for CSI derivation based on a reduced number of frequency resources the UE 3 reports reserved or zero values for CQI and/or PMI for subbands where CSI-RS is not transmitted during SBFD.

For other CSI quantities (e.g. wideband CQI, SINR) the quantities are determined based on only the frequency resources, or ports, for which CSI-RS transmissions occur during SBFD slots.

It will be appreciated that the different techniques (and CSI derivation methods) described with reference to FIGS. 26A to 26D are not mutually exclusive.

For example, different techniques (and/or different CSI derivation methods) can be used for different scenarios.

For example, when the UE 3 is configured with an RRC configuration indicating when part of CSI-RS resources will not be transmitted/will be punctured, then the UE 3 may use the technique illustrated in FIG. 26C. When a base station provides SBFD slot information using DCI to UE 3, then the UE 3 may use the technique illustrated in FIG. 26C together with the second method for CSI derivation based on a reduced number of ports. For aperiodic CSI triggering on the other hand, the UE 3 may use the technique illustrated in FIG. 26C together with the first method for CSI derivation based on a reduced number of ports.

It will be appreciated that similar solutions, to those described with reference to FIGS. 26A to 26D may be employed for the purposes of radio link monitoring using CSI-RS.

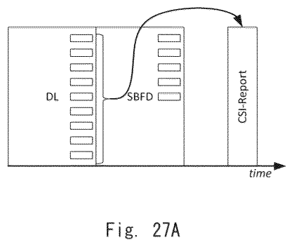

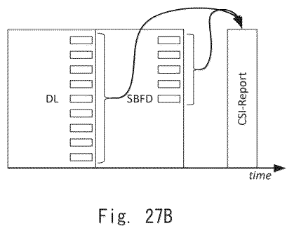

FIGS. 27A and 27B each illustrate a different possible technique that may be employed for CSI reporting when the time restriction is not configured and the CSI report may, therefore, be compiled based on measurements from both CSI-RS transmitted in an SBFD slots and CSI-RS transmitted in a legacy TDD DL slot.

FIG. 27A illustrates a technique in which, for a CSI report which requires the UE 3 to compute CSI based on measurements over ports and/or a frequency region for which transmissions are not received during SBFD slots, the UE 3 discards/ignores those CSI-RS occasions that coincide with SBFD slots for CSI reporting purposes. Instead, the UE 3 uses the CSI-RS measurement performed during one or more preceding legacy TDD DL slots (i.e. when all the ports and frequency region of CSI-RS resource are available).

FIG. 27B illustrates a technique in which the UE 3, when computing CSI, uses both the measurements made for the SBFD slot (for the ports and/or a frequency region for which transmissions can be received during SBFD slots) and one or more previous sets of CSI-RS measurements performed during one or more earlier non-SBFD slots. When using the measurements from SBFD slots, however, the measurements corresponding to frequency resources and ports which are not transmitted during SBFD are not used for CSI computation. Whilst this exemplary technique is similar to the technique illustrated in FIG. 26C, in this example, the CSI reporting performed by the UE 3 is based on measurements performed in respect of the full set of ports and frequency resources corresponding to CSI-RS resource of one or more legacy TDD DL slots (albeit in combination with measurements for a reduced set of ports/reduced frequency region made for the SBFD slot).

It will be appreciated that similar solutions, to those described with reference to FIGS. 27A and 27B may be employed for the purposes of radio link monitoring using CSI-RS.

### <Updating the DL and UL Transmission Parameters>

Beneficially, the communication system 1 can also implement one or more techniques for updating DL and/or UL transmission parameters (e.g., codebook parameters, ports, and/or the like) for the transmission and/or reception of data during SBFD slots.

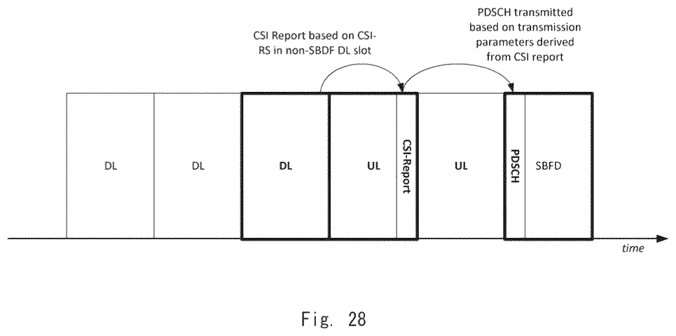

As explained above, the UE 3 may indicate a DL codebook to the base station 5 (e.g., via CSI reports), which is determined for a full set of ports/antenna elements available for CSI-RS in non-SBFD slots/symbols. Similarly, the base station may determine a UL codebook based on SRS transmissions from the UE 3 in non-SBFD slots/symbols. However, during SBFD slots some of the CSI-RS ports will likely be disabled for data transmission and/or reception (e.g., on the PDSCH and/or PUSCH). There is the potential, therefore, for the transmission parameters for DL data (e.g., on the PDSCH) transmitted by the base station 5 in an SBFD slot to be based on a CSI report that is derived from CSI-RS transmitted in a non-SBFD DL slot/symbol. This is illustrated in FIG. 28, which is a simplified timing diagram illustrating a potential relationship between CSI-reporting and downlink data transmission.

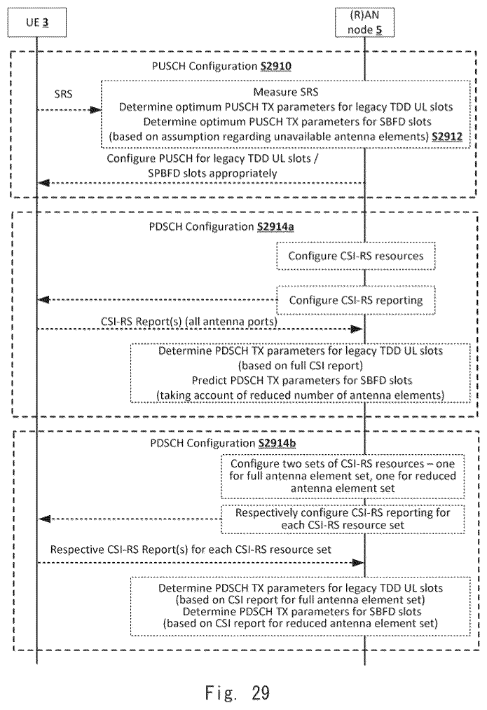

Techniques for updating DL and/or UL transmission parameters will now be described in more detail with reference to FIG. 29, which is a simplified sequence diagram illustrating a number of different procedures that can be employed in the communication system for updating transmission parameters.

As seen at S2910, for example, for UL (e.g., PUSCH) transmissions, the base station 5 is able to determine (at S2912) optimum transmission parameters for SBFD slots and non-SBFD slots (e.g. precoding, rank, ports, and/or the like) based on the SRS transmission from UEs 3. Accordingly, in one technique, the base station can prepare different sets of codebooks including one set for legacy TDD UL slots, and another set for SBFD slots based on an assumption that a certain set of antenna elements are not available for UL transmission at the UE 3 during those slots. Accordingly, the base station 5 may configure PUSCH transmission parameters for SBFD slots and for non-SBFD slots appropriately.

However, as explained with reference to FIG. 28, for DL (e.g., PDSCH) transmissions, the transmission parameters (e.g. precoding, rank, CQI, beam weights) may need to be determined, by the base station 5, based on a CSI report received in an earlier legacy TDD UL slot/symbol that is derived from CSI-RS transmitted in an earlier legacy TDD DL slot/symbol.

In one technique illustrated in FIG. 29 (at S2914a), for PDSCH transmission parameters, the base station 5 may simply continue to use (legacy) CSI reports based on measurements in a legacy TDD DL slot for a full set of antenna ports and/or frequency range. For example, the UE 3 may provide CSI reports (including PMI, rank indication, etc.) corresponding to all the CSI ports and the base station may predict the transmission parameters for a reduced set of antennas from this legacy CSI report. Accordingly, the base station 5 may configure PDSCH transmission parameters for SBFD slots based on the prediction and may configure PDSCH transmission parameters for non-SBFD slots based on the full CSI reporting in respect of the full antenna set.

It will be appreciated, however, that while this technique has the benefit of simplicity it may sometimes result in an incorrect setting of parameters (for example, a rank applicable to reduced set of antenna elements could be smaller than the rank identified for full set) if the prediction by the base station 5 is not correct.

In another technique illustrated in FIG. 29 (at S2914b), the base station 5 may configure (e.g., in the CSI report configuration) different (sets of) CSI reports to be provided based on different measurements of CSI-RS transmitted in the same legacy TDD slot. Specifically, one set of CSI-RS resources and associated CSI-RS reports may be configured for use in respect of non-SBFD (legacy TDD DL) slots, and another set of CSI-RS resources and associated CSI-RS reports may be configured for use in respect of SBFD slots.

For example, one set of CSI-RS resources (and associated CSI-RS reports) may be for a full antenna set and another set of CSI-RS resources (and associated CSI-RS reports) may be configured for a reduced antenna set. Accordingly, the base station 5 may configure PDSCH transmission parameters for SBFD slots based on CSI reporting in respect of the reduced antenna set and may configure PDSCH transmission parameters for non-SBFD slots based on CSI reporting in respect of the full antenna set.

It will be appreciated that this technique can beneficially be implemented using current signalling capabilities which already allow the possibility of configuring multiple (sets of) CSI-RS resources and associated CSI-RS reports. Moreover, this technique can reduce the risk an incorrect transmission parameter setting. Nevertheless, this technique has the potential to increase the signalling overhead both in terms transmission of CSI resources and in terms of the transmission of CSI reports.

Beneficially, the communication system 1 may employ one or more techniques that reduce the CSI-RS transmission overhead.

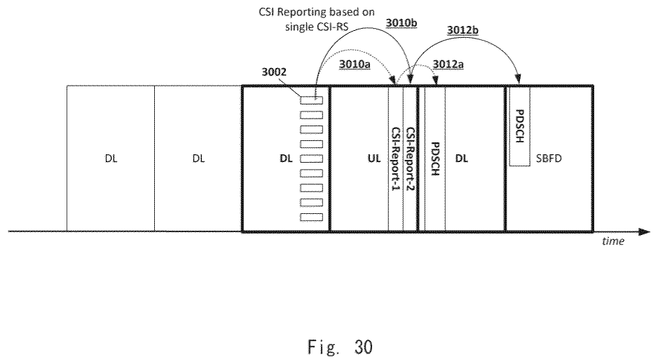

FIG. 30 is a simplified timing diagram illustrating one technique that may be used to reduce the CSI-RS transmission overhead.

In this technique, a single CSI-RS resource 3002 is configured for associated CSI reporting for both the PDSCH of a legacy TDD DL slot (as illustrated at 3010a) and for the PDSCH of an SBFD slot (as illustrated at 3010b). Each CSI-RS report based on the single CSI-RS may then be used for respectively configuring corresponding transmission parameters for the PDSCH for a legacy TDD DL slot (as illustrated at 3012a), and corresponding transmission parameters for the PDSCH for an SBFD slot (as illustrated at 3012b). In this technique, the base station 5 may configure additional parameters, for example, parameters identifying which antenna ports and/or frequency resources to respectively measure for each CSI report. This configuration of additional parameters can be done using the CSI-RS configuration, or using the associated CSI report configuration (e.g., as described with reference to FIG. 9).

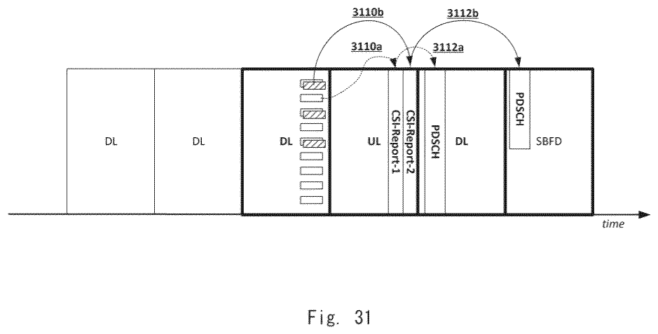

FIG. 31 is a simplified timing diagram illustrating another technique that may be used to reduce the CSI-RS transmission overhead.

In this technique, separate CSI-RS resources are respectively configured for CSI reporting for the PDSCH of a legacy TDD DL slot (as illustrated at 3110a), and for CSI reporting for the PDSCH of an SBFD slot (as illustrated at 3110b). Each CSI-RS report based on a different respective CSI-RS may be used for respectively configuring corresponding transmission parameters for the PDSCH for a legacy TDD DL slot (as illustrated at 3112a), and corresponding transmission parameters for the PDSCH for an SBFD slot (as illustrated at 3112b). In this technique, the base station 5 may configure additional parameters, for example, parameters identifying which antenna ports and/or frequency resources to respectively measure for each CSI report. This configuration of additional parameters can be done using the CSI-RS configuration, or using the associated CSI report configuration (e.g., as described with reference to FIG. 9). It will be appreciated that the two CSI-RS resources can be overlapping in radio resources to reduce the signalling overhead of transmitting essentially the same CSI-RS resource twice.

Beneficially, in this example, the UE 3 can assume quasi co-located (QCL) (all types) antenna ports for both the CSI-RS resources—i.e., assuming that the transmissions from one or more respective antenna ports for each of the CSI-RS resources share the same channel characteristics—to simplify UE's decoding effort.

Beneficially, the communication system 1 may also employ one or more techniques that reduce the CSI reporting overhead.

These techniques take advantage of the fact that when one antenna panel is effectively switched off (e.g., for the purposes of DL transmissions), some parameters for CSI reporting are less likely to change than others. For example, CQI (both subband and wideband) is likely to be impacted due to a change in overall antenna gain. Subband PMI values, on the other hand, may or may not change depending on channel variation between the different antenna panels. Similarly, the RI value may or may not change depending on the channel variation between the different antenna panels.

Accordingly, given that some of the parameters can remain common between the PDSCH transmission in SBFD and non-SBFD slots, the UE 3 does not have to transmit the entire CSI report for PDSCH associated to SBFD slots and for PDSCH associated to legacy DL slots separately. For discussions sake, we will subsequently use “SBFD PDSCH” to mean “PDSCH transmission during SBFD slots” and “legacy DL PDSCH” to mean “PDSCH transmission during legacy DL slots”.

Hence, the communication system 1 may beneficially employ one or more mechanisms for joint coding of CSI reports respectively corresponding to SBFD PDSCH and legacy DLPDSCH to reduce CSI reporting overhead. Specifically, the CSI reporting corresponding to an SBFD PDSCH may be interpreted (decoded) based on a related CSI report corresponding to a legacy DL PDSCH (or vice versa).

Referring, for example to CQI, while wideband CQI is ideally reported for both one or more SBFD PDSCHs and one or more legacy DL PDSCHs, the number of bits required for wideband CQI encoding for SBFD PDSCH may be reduced by indicating a delta value relative to a wideband CQI for legacy DL PDSCH.

Referring, to subband CQI, there are a number of different ways to reduce the CSI reporting overhead in respect of SBFD operation. For example, the UE 3 may simply not report subband CQI for SBFD PDSCH. Alternatively, subband CQI for SBFD PDSCH may reported by the UE 3 conditionally, for example, based on the condition that a predetermined number of subband CQIs for SBFD PDSCH differ from (or possibly are less than) the corresponding subband CQIs for legacy DL PDSCH (e.g., by no less than a threshold value). It will be appreciated that to support this, the UE 3 may include an indication in the CSI reporting for SBFD PDSCH to indicate whether subband CQI is included or not.

In a variation on this, the UE 3 may indicate in a CSI report the number of subband CQIs for SBFD PDSCH that differ from (or possibly are less than) the corresponding subband CQIs for legacy DL PDSCH (e.g., by no less than a threshold value). In this case, the base station 5, may decide to trigger and additional aperiodic CSI report (e.g., based on the reported number of subband CQIs for SBFD PDSCH) for acquiring a report for the subbands from the UE 3.

In another variation the UE 3 may indicate, in a CSI report, a respective subband CQI for SBFD PDSCH for a subset of subbands (e.g., for only every Nth subband or the like).

Referring, to subband PMI, there are a number of different ways to reduce the CSI reporting overhead in respect of SBFD PDSCH. Specifically, any of the techniques described with respect to subband CQI for SBFD PDSCH may be applied in respect of subband PMI for SBFD PDSCH.

Referring to encoding of the Rank Indicator, and additional value may need to be indicated for SBFD PDSCH. Nevertheless, to reduce the CSI reporting overhead, the UE 3 may indicate the PMI columns (or layers) which are valid for the RI value for SBFD PDSCH conditionally when the RI value for SBFD PDSCH is different from the RI value for legacy TDD DL PDSCH.

It will be appreciated that if a full CSI report cannot be transmitted by the UE 3, then the base station may need to trigger an aperiodic report to obtain the full report. Beneficially, in order to avoid retransmission of the related CSI-RS (and hence the additional resource overhead such retransmission would necessitate), the base station 5 may be configured for triggering an aperiodic CSI report that is not associated with new CSI-RS transmissions. When such an aperiodic CSI report is triggered the UE 3 may compile a CSI report based on measurements which have already been performed rather than new measurements of newly transmitted CSI-RS.

It will also be appreciated that a reduction in resource overhead may be achieved by avoiding repeated transmission of a full CSI report for SBFD PDSCH. For example, rather than reporting all the CSI information for SBFD PDSCH in a single high priority report, one or more of the CSI reporting fields for SBFD PDSCH mentioned above may be reported as part of a ‘lower priority’ (e.g., ‘part-2’) CSI report. Accordingly, the priority of transmitting the information represented by these fields can be reduced, and the associated ‘part-2’ CSI report can be transmitted less frequently than other ‘higher priority’ fields of a CSI report.

It will be appreciated that CSI information for SBFD PDSCH may be transmitted as part of the same CSI report as CSI information for legacy TDD DL PDSCH or may be transmitted as part of a different CSI report. Where for same CSI report, additional fields (e.g., including codebook, ports, frequency resources to be measured for SBFD PDSCH, and/or the like) are configured within the same CSI report, the base station 5 may indicate which additional quantities are to be reported (e.g., in a CSI report configuration).

Where different CSI reports are configured by the base station 5, some quantities of the CSI report for SBFD PDSCH may be determined based on parameters of the CSI report of legacy TDD DL PDSCH. In this case, the base station may indicate an association between the two CSI reports.

### <UL Decoding>

It will be appreciated that with lower number of antenna elements present at the base station for reception of UL in SBFD slots, the UL decoding performed at the base station 5 has the potential to deteriorate during SBFD slots.

A number of techniques that may be implemented in the communication system 1 for improving UL decoding performance in the context of the implementation of SBFD will now be described in more detail be way of example only.

Beneficially, the techniques for improving UL decoding performance include enhancements to UL transmission parameters (e.g., UL power).

For example, as explained above, for PUSCH/PUCCH power control multiple power control states are defined where one state may be indicated using DCI for the PUSCH or a MAC CE for PUCCH. Accordingly, the communication system 1 may implement a mechanism based on this in which the base station 5 switches between different power control states between an SBFD slot and a non-SBFD slot. Nevertheless, while having the benefit of simple implementation, such a mechanism of power state change requires triggering using DCI or a MAC CE which may result in additional signalling overhead (especially if SBFD occasions occur frequently).

Beneficially, the techniques that may be implemented in the communication system 1 may include additional power control enhancements.

For example, in one technique, SBFD specific power states are defined for UL transmission during SBFD operation. This may be implemented, for example, by defining one or more SBFD specific power offsets to be applied for UL transmission during SBFD occasions and/or by configuring additional SBFD specific values for existing power control values in spatial relation information (e.g., PUCCH spatial relation information) with corresponding spatial relation information identifiers (e.g., PUCCH spatial relation information identifiers) which are mapped to SBFD.

The UE 3 can then apply appropriate parameters/power offset values associated with SBFD whenever the UE 3 performs UL transmission during SBFD slots/symbols without requiring additional signalling.

It will be appreciated that these enhancements are applicable to any uplink communication (including, for example, the PUSCH/PUCCH/PRACH and/or SRS). It will also be appreciated that different power configuration values may be configured for different channels.

Beneficially, the techniques for improving UL decoding performance include enhancements for UL encoding and/or UL communication repetition for control channels when UE 3 performs UL transmission during SBFD slots/symbols.

Specifically, in one technique, the UE 3 is (pre) configured with a different respective encoding rule and/or a different respective set of encoding parameters are respectively defined for uplink (e.g., PUCCH) transmissions in SBFD slots/symbols than for uplink (e.g., PUCCH) transmissions in legacy TDD UL slots/symbols. The UE 3 can then apply the specific encoding rule and/or specific set of encoding parameters for SBFD in SBFD slots/symbols, and the other encoding rule and/or set of encoding parameters in legacy TDD UL slots/symbols, to allow enhanced decoding in respect of UL transmissions in SBFD slots/symbols.

In another technique, the UE 3 is (pre) configured with a different respective number of repetitions for uplink (e.g., PUCCH/PRACH and/or SRS) transmissions in SBFD slots/symbols, than for uplink (e.g., PUCCH/PRACH and/or SRS) transmissions in legacy TDD UL slots/symbols. For example, a greater number of repetitions may be used for SBFD slots/symbols than for legacy TDD UL slots/symbols. The UE 3 can then use the specific number of repetitions for SBFD UL communication in SBFD slots/symbols, and the other number of repetitions for UL communication in non-SBFD slots/symbols, to allow enhanced decoding in respect of UL transmissions in SBFD slots/symbols.

In another technique, the UE 3 is (pre) configured with a different respective set of UL communication (e.g., PUCCH) resources for uplink (e.g., PUCCH) transmissions in SBFD slots/symbols, than for uplink (e.g., PUCCH) transmissions in legacy TDD UL slots/symbols. The UE 3 can then use the specific resource configuration for SBFD UL communication in SBFD slots/symbols, and the other resource configuration for UL communication in legacy TDD UL slots/symbols, to allow enhanced decoding in respect of UL transmissions in SBFD slots/symbols.

In another technique, the UE 3 is configured to apply a different respective RACH format (and associated parameters) in respect of SBFD slots/symbols, than in respect of legacy TDD UL slots/symbols to allow enhanced decoding in respect of RACH transmissions in SBFD slots/symbols.

### (User Equipment)

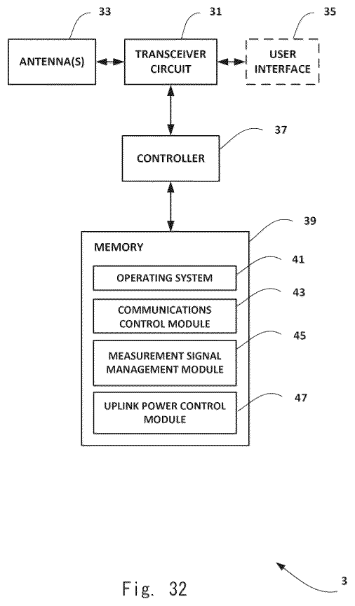

FIG. 32 is a schematic block diagram illustrating the main components of a UE 3 as shown in FIG. 2.

As shown, the UE 3 has a transceiver circuit 31 that is operable to transmit signals to and to receive signals from a base station 5 via one or more antenna 33 (e.g., comprising one or more antenna elements). The UE 3 has a controller 37 to control the operation of the UE 3. The controller 37 is associated with a memory 39 and is coupled to the transceiver circuit 31.

Although not necessarily required for its operation, the UE 3 might, of course, have all the usual functionality of a conventional UE 3 (e.g. a user interface 35, such as a touch screen/keypad/microphone/speaker and/or the like for, allowing direct control by and interaction with a user) and this may be provided by any one or any combination of hardware, software, and firmware, as appropriate. Software may be pre-installed in the memory 39 and/or may be downloaded via the telecommunications network or from a removable data storage device (RMD), for example.

The controller 37 is configured to control overall operation of the UE 3 by, in this example, program instructions or software instructions stored within memory 39. As shown, these software instructions include, among other things, an operating system 41, a communications control module 43, a measurement signal management module 45, and an uplink power control module 47.

The communications control module 43 is operable to control the communication between the UE 3 and its one or more serving base stations 5 (and other communication devices connected to the base station 5, such as further UEs and/or core network nodes). The communications control module 43 is configured for the overall handling uplink communications via associated uplink channels (e.g. via a physical uplink control channel (PUCCH), random access channel (RACH), and/or a physical uplink shared channel (PUSCH)) including both dynamic and semi-static signalling (e.g., SRS). The communications control module 43 is also configured for the overall handling receipt of downlink communications via associated downlink channels (e.g. via a physical downlink control channel (PDCCH) and/or a physical downlink shared channel (PDSCH)) including both dynamic and semi-static signalling (e.g., CSI-RS). The communications control module 43 is responsible, for example, for determining the resources to be used by the UE 3, for determining how slots/symbols are configured (e.g., for UL, DL or SBFD communication, or the like), for determining which bandwidth parts are configured for the UE 3, for determining how uplink transmissions should be encoded, for applying any SBFD specific communication configurations appropriately, etc.

The measurement signal management module 45 is responsible, subject to overall control by the communications control module 43, for managing tasks related to the reception and measurement of downlink signals for measurement at the UE 3 such as reference signals and/or synchronisation signals (e.g., SSBs, CSI-RS, DMRS, and/or the like) and the transmission of uplink signals for measurement at the base station 5 (e.g., SRS). The measurement signal management module 45 is also responsible for generating appropriate reports based on the measurements (e.g., CSI reports carrying appropriate information such as CQI, PMI, RI, LI, CRI, cri-RSRP, cri-SINR and/or the like depending on appropriate configuration from the base station 5). The measurement signal management module 45 is also responsible for deriving propagation channel parameters (e.g., from DMRS) for the purposes of accurately decoding the PDSCH.

The uplink power control module 47 is responsible, subject to overall control by the communications control module 43, for performing power control for uplink transmissions (PUSCH/PUCCH/PRACH/SRS and/or the like) based on the UEs 3 preconfigured power control parameters and/or parameters configured by the base station 5.

### (Base Station)

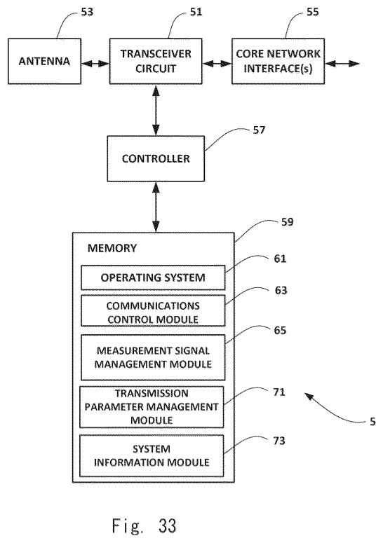

FIG. 33 is a schematic block diagram illustrating the main components of the base station 5 for the communication system 1 shown in FIG. 2. As shown, the base station 5 has a transceiver circuit 51 for transmitting signals to and for receiving signals from the communication devices (such as UEs 3) via one or more antenna 53 (e.g. a single or multi-panel antenna array/massive antenna), and a core network interface 55 (e.g. comprising the N2, N3 and other reference points/interfaces) for transmitting signals to and for receiving signals from network nodes in the core network 7. Although not shown, the base station 5 may also be coupled to other base stations via an appropriate interface (e.g. the so-called ‘Xn’ interface in NR).

The base station 5 has a controller 57 to control the operation of the base station 5. The controller 57 is associated with a memory 59. Software may be pre-installed in the memory 59 and/or may be downloaded via the communication system 1 or from a removable data storage device (RMD), for example. The controller 57 is configured to control the overall operation of the base station 5 by, in this example, program instructions or software instructions stored within memory 59.

As shown, these software instructions include, among other things, an operating system 61, a communications control module 63, a measurement signal management module 65, a transmission parameter management module 71, and a system information module 73.

The communications control module 63 is operable to control the communication between the base station 5 and UEs 3 and other network entities that are connected to the base station 5. The communications control module 63 is configured for the overall control of the reception and decoding of uplink communications, via associated uplink channels (e.g. via a physical uplink control channel (PUCCH), a random-access channel (RACH), and/or a physical uplink shared channel (PUSCH)) including both dynamic and semi-static signalling (e.g., SRS).

The communications control module 63 is also configured for the overall handling the transmission of downlink communications via associated downlink channels (e.g. via a physical downlink control channel (PDCCH) and/or a physical downlink shared channel (PDSCH)) including both dynamic and semi-static signalling (e.g., CSI-RS). The communications control module 63 is responsible for managing full duplex (e.g., SBFD) communication including, where appropriate, the segregation of UL and DL communication via different physical antenna elements. The communications control module 63 is responsible, for example, for managing the mapping of downlink communication to appropriate logical antenna port/antenna element configurations, and for applying appropriate precoding and/or beamforming.

The communications control module 63 is also responsible, for example, for determining and scheduling the resources to be used by the UE 3 for receiving in DL/transmitting in UL, for configuring slots/symbols appropriately (e.g., for UL, DL or SBFD communication, or the like), for configuring one or more bandwidth parts for the UE 3, and for providing related configuration signalling to the UE 3.

The measurement signal management module 65 is responsible, subject to overall control by the communications control module 63, for managing tasks related to the transmission of downlink signals for measurement at the UE 3 such as reference signals and/or synchronisation signals (e.g., SSBs, CSI-RS, DMRS, and/or the like) and the reception and measurement of uplink signals for measurement at the base station 5 (e.g., SRS).

The measurement signal management module 65 is also responsible for configuring appropriate resources for such measurement signals (e.g., CSI-RS resources) and for configuring UE reporting related to the measurement signals (e.g., CSI reports carrying appropriate information such as CQI, PMI, RI, LI, CRI, cri-RSRP, cri-SINR and/or the like depending on appropriate configuration from the base station 5). The measurement signal management module 65 is also responsible for triggering, where appropriate, reporting related to the measurement signals (e.g., aperiodic CSI-RS reporting or the like).

The transmission parameter management module is responsible, subject to overall control by the communications control module 63, for managing downlink transmission parameters applied at the base station 5 and uplink transmission parameters applied at the UE 3 including, for example, precoding (codebook) parameters, logical antenna port parameters, rank parameters, power control parameters, and/or the like.

### (Modifications and Alternatives)

A detailed embodiment has been described above. As those skilled in the art will appreciate, a number of modifications and alternatives can be made to the above embodiments whilst still benefiting from the disclosure embodied therein.

It will be appreciated, for example, that whilst cellular communication generation (2G, 3G, 4G, 5G, 6G etc.) specific terminology may be used, in the interests of clarity, to refer to specific communication entities, the technical features described for a given entity are not limited to devices of that specific communication generation. The technical features may be implemented in any functionally equivalent communication entity regardless of any differences in the terminology used to refer to them.

In the above description, the UEs and the base station are described for ease of understanding as having a number of discrete functional components or modules. Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

In the above embodiments, a number of software modules were described. As those skilled in the art will appreciate, the software modules may be provided in compiled or un-compiled form and may be supplied to the base station, to the mobility management entity, or to the UE as a signal over a computer network, or on a recording medium. Further, the functionality performed by part, or all of this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The memories shown above may be formed by a volatile memory or a nonvolatile memory, however, the memories may be formed by a combination of a volatile memory and a nonvolatile memory.

In the above aspects, a number of software modules were described. As those skilled in the art will appreciate, the software modules may be provided in compiled or un-compiled form and may be supplied to the UE, the (R)AN node, and the core network node as a signal over a computer network, or on a recording medium. Further, the functionality performed by part or all of this software may be performed using one or more dedicated hardware circuits. However, the use of software modules is preferred as it facilitates the updating of the UE, the (R)AN node, and the core network node in order to update their functionalities.

A software to configure the software modules can be stored using various types of non-transitory computer readable media to be supplied to a computer. The non-transitory computer readable media include various types of tangible storage media. Examples of the non-transitory computer readable medium include a magnetic recording medium (for example, a flexible disk, a magnetic tape, or a hard disk drive), an optical magnetic recording medium (for example, a magneto-optical disk), a CD-ROM (read only memory), a CD-R, a CD-R/W, and a semiconductor memory such as a mask ROM, a programmable ROM (PROM), an erasable PROM (EPROM), a flash ROM, or a random access memory (RAM). In addition, the program may be supplied to the computer by various types of transitory computer readable media. Examples of the transitory computer readable media include electric signals, optical signals, and electromagnetic waves. The transitory computer readable medium can supply the program to the computer via a wired communication path such as an electric wire and an optical fiber, or a wireless communication path.

The base station may comprise a ‘distributed’ base station having a central unit ‘CU’ and one or more separate distributed units (DUs).

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine type communication applications.

TABLE 4

| Service Area | MTC applications |
|---|---|
| Security | Surveillance systems |
| | Backup for landline |
| | Control of physical access |
| | (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch exchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VOLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and exemplary embodiments described in the present document. Needless to say, these technical ideas and embodiments are not limited to the above-described UE and various modifications can be made thereto.

It can be seen in summary that in one above example there is disclosed a method performed by a user equipment (UE) (and a corresponding UE, access network node, and method performed by an access network node), the method comprising: communicating with an access network node in at least one time resource of a plurality of time resources, wherein the plurality of time resources include at least one time resource configured for downlink communication, and at least one time resource configured for full duplex communication: receiving, from the access network node, configuration information for at least one downlink reference signal to be reported, the configuration information including information indicating a configuration of at least one downlink reference signal resource for the at least one downlink reference signal to be reported; reporting, to the access network node, based on the configuration information: first information, based on at least one measurement of the at least one downlink reference signal transmitted using the at least one downlink reference signal resource, for configuring a first transmitter parameter configuration for at least one physical downlink shared channel (PDSCH) transmitted in at least one time resource configured for downlink communication, and second information, based on at least one measurement of the at least one downlink reference signal transmitted using the at least one downlink reference signal resource, for configuring a second transmitter parameter configuration for at least one PDSCH transmitted in at least one time resource configured for full duplex communication; and receiving, from the access network node, in at least one time resource of the plurality of time resources, the at least one PDSCH wherein: in a case where the at least one PDSCH is received in at least one time resource configured for downlink communication, the at least one PDSCH is transmitted using the first transmitter parameter configuration; and in a case where the at least one PDSCH is received in at least one time resource configured for full duplex communication, the at least one PDSCH is transmitted using the second transmitter parameter configuration.

It can also be seen in summary that in one above example there is disclosed a method performed by a user equipment (UE) (and a corresponding UE, access network node, and method performed by an access network node), the method comprising: receiving, from an access network node, configuration information for a resource for at least one downlink reference signal; performing at least one measurement of the at least one downlink reference signal based on the configuration information; sending, to the access network node, based on the configuration information and the at least one measurement: first information for configuring a first transmitter parameter configuration for at least one physical downlink shared channel (PDSCH) transmitted in at least one time resource configured for a communication scheme, and second information for configuring a second transmitter parameter configuration for at least one PDSCH transmitted in at least one time resource configured for another communication scheme; and receiving, from the access network node, at least one PDSCH, wherein: in a case where the at least one PDSCH is received in the at least one time resource configured for the communication scheme, the at least one PDSCH is transmitted using the first transmitter parameter configuration; and in a case where the at least one PDSCH is received in the at least one time resource configured for the another communication scheme, the at least one PDSCH is transmitted using the second transmitter parameter configuration.

The configuration information may include information indicating a configuration of a single downlink reference signal resource. Both the first transmitter parameter configuration and the second transmitter parameter configuration are based on the at least one measurement in respect of the single downlink reference signal resource. Both the first transmitter parameter configuration and the second transmitter parameter configuration may be based on reported information based on the at least one measurement in respect of the single downlink reference signal resource.

The configuration information may indicate, for the configuration of the single downlink reference signal resource: at least one of a first port or a first frequency resource for reporting the first information, and at least one of a second port or a second frequency resource for reporting the second information. The configuration information may include information indicating a first configuration of at least one first downlink reference signal resource and a second configuration of at least one second downlink reference signal resource.

The first transmitter parameter configuration may be based on the at least one measurement in respect of the at least one first downlink reference signal resource. The second transmitter parameter configuration may be based on the at least one measurement in respect of the at least one second downlink reference signal resource. The first transmitter parameter configuration may be based on reported information based on the at least one measurement in respect of the at least one first downlink reference signal resource. The second transmitter parameter configuration may be based on reported information based on the at least one measurement in respect of the at least one second downlink reference signal resource.

The first configuration of at least one first downlink reference signal resource may be based on a first set of at least one resource. The second configuration may be based on a second set of at least one resource and the at least one resource of the first set and the at least one resource of the second set may overlap. The first information may include an indication of at least one first wideband cell quality indicator (CQI).

The second information may include an indication of at least one second wideband CQI, and the indication of at least one second wideband CQI may indicate the at least one second wideband CQI relative to the first CQI.

The first information may include an indication of at least one subband cell quality indicator (CQI), and the second information may not include any indication of a subband CQI. The first information may include an indication of at least one first subband cell quality indicator (CQI), and the second information may include an indication of at least one second subband CQI based on a condition that a number of second subband CQIs for indication in the second information differ from corresponding first subband CQIs by at least a threshold value.

The second information may include an indication of at least one second subband CQI based on a condition that the number of subband CQIs for indication in the second information are less than the corresponding first subband CQIs by at least the threshold value. The second information may include an indication of whether or not at least one second subband CQI is included in the second information.

The first information may include an indication of at least one first subband cell quality indicator (CQI), and the second information may include an indication of how many second subband CQIs differ from corresponding first subband CQIs by at least a threshold value. The second information may include an indication of how many second subband CQIs are less than corresponding first subband CQIs by at least the threshold value.

The first information may include an indication of at least one first subband cell quality indicator (CQI), and the second information may include an indication of at least one second subband CQI for a subset of subbands.

The second information may include an indication of at least one second subband CQI for a subset of subbands comprising every Nth subband where N is an integer.

The first information may include an indication of at least one subband precoding matrix indicator (PMI), and the second information may not include any indication of a subband PMI. The first information may include an indication of at least one first subband precoding matrix indicator (PMI), and the second information may include an indication of at least one second subband PMI based on a condition that a number of second subband PMIs for indication in the second information differ from corresponding first subband PMIs by at least a threshold value.

The second information may include an indication of whether or not at least one second subband PMI is included in the second information. The first information may include an indication of at least one first precoding matrix indicator (PMI), and the second information may include an indication how many second subband PMIs differ from corresponding first subband CQIs by at least a threshold value.

The first information may include an indication of at least one first precoding matrix indicator (PMI), and the second information may include an indication of at least one second subband PMI for a subset of subbands. The second information may include an indication of at least one second subband PMI for a subset of subbands comprising every Nth subband, where N is an integer.

The first information may include an indication of at least one first rank indicator (RI), the second information may include at least one second RI. In a case where a value of the at least one second RI is different to a value of a corresponding at least one first RI, the second information may include an indication of at least one precoding matrix indicator (PMI) column, or layer, which is valid for the value of the at least one second RI.

The second information may form part of a partial report of information based on the at least one measurement of the at least one downlink reference signal transmitted using the at least one downlink reference signal resource, and the method may further comprise receiving, from the access network node, trigger information for triggering transmission of a further report; and transmitting the further report. The trigger information may indicate the further report should be based on previously performed measurements.

The second information may be transmitted as part of the same report as the first information. The configuration information may indicate at least one parameter that is to be reported as part of the second information. The first information may be transmitted as part of a first report, the second information may be transmitted as part of a second report that is different to the first report. At least one parameter reported as part of the second report may be determined based on at least one parameter that is reported as part of the first report. The configuration information may indicate an association between the first and second reports.

The first information and the second information may be based on respective measurement in at least one first downlink reference signal resource and in at least one second downlink reference signal resource, and the at least one first downlink reference signal resource and the at least one second downlink reference signal resource may at least partially overlap. The first information and the second information may be jointly coded.

It can also be seen in summary that in one above example there is disclosed a method performed by a user equipment (UE) (and a corresponding UE, access network node, and method performed by access network node), the method comprising: communicating with an access network node in at least one time resource of a plurality of time resources, wherein the plurality of time resources include at least one time resource configured for downlink communication, and at least one time resource configured for full duplex communication: receiving, from the access network node: first information indicating a first configuration related to transmission of at least one downlink reference signal in at least the at least one time resource configured for downlink communication, and second information indicating at least one of: a second configuration related to transmission of the at least one downlink reference signal in the at least one time resource configured for full duplex communication; or that the at least one downlink reference signal will not be transmitted in at least one time resource of the plurality of time resources; performing at least one measurement of at least one downlink reference signal transmitted in at least one time resource of the plurality of time resources; and transmitting at least one report to the at least one access network node based on the at least one measurement, wherein the at least one report includes information based on at least one of: the first information, or the second information.

The first information may indicate a first resource configuration for transmission of the at least one downlink reference signal in the at least one time resource configured for downlink communication, and the second information indicates a second resource configuration for transmission of the at least one downlink reference signal in the at least one time resource configured for full duplex communication.

The second information may indicate a power value, to be applied for transmission of the at least one downlink reference signal in the at least one time resource configured for full duplex communication, that is different to another power value to be applied for transmission of the at least one downlink reference signal in the at least one time resource configured for downlink communication. The second information may indicate an antenna port configuration, to be used for transmission of the at least one downlink reference signal in the at least one time resource configured for full duplex communication, that is different to another antenna port configuration to be used for transmission of the at least one downlink reference signal in the at least one time resource configured for downlink communication. The second information may indicate the antenna port configuration per resource for the at least one downlink reference signal. The second information may indicate the antenna port configuration by indicating at least one of: a list; a range; or a mask; of antenna port numbers. The second information may indicate the antenna port configuration by indicating at least one of: a list; a range; or a mask; of antenna panels for a multi-panel antenna.

The second information may indicate a frequency resource configuration, to be used for transmission of the at least one downlink reference signal in the at least one time resource configured for full duplex communication, that is different to another frequency resource configuration to be used for transmission of the at least one downlink reference signal in the at least one time resource configured for downlink communication. The second information may indicate the frequency resource configuration by indicating a subset of at least one frequency resource configured by the first configuration that is punctured, or that is not punctured, during the at least one time resource configured for full duplex communication.

The second information may indicate the frequency resource configuration by indicating at least one frequency resource for use in place of at least one frequency resource configured by the first configuration.

The first information may indicate a first configuration that includes: a first parameter set including at least one first parameter related to the transmission of the at least one downlink reference signal in the at least one time resource configured for downlink communication; and may indicate a second parameter set including at least one second parameter related to the transmission of the at least one downlink reference signal in the at least one time resource configured for full duplex communication; and the second information may indicate the at least one second parameter by reference to the first information.

The first parameter set may relate to a first report configuration for reporting information related to the transmission of the at least one downlink reference signal in the at least one time resource configured for downlink communication, and the second parameter set relates to a second report configuration for reporting information related to the transmission of the at least one downlink reference signal in the at least one time resource configured for full duplex communication.

The second information may be received from the access network node in downlink control information for triggering reporting of information related to the transmission of the at least one downlink reference signal. The second information may indicate that, for at least one time occasion, the at least one downlink reference signal will not be transmitted in at least one downlink reference signal resource during that at least one time occasion.

The second information may identify the at least one time occasion during which at least one downlink reference signal will not be transmitted. The second information may indicate at least one downlink reference signal resource of a resource set that is to be deactivated during the at least one time occasion. The second information may define at least one downlink reference signal resource for which transmission will be restricted during the at least one time occasion, and the method may further comprise determining at least one time occasion for which transmission will be restricted based on the at least one time resource configured for full duplex communication.

The at least one time resource configured for full duplex communication may be configured based on at least one time resource configuration of a plurality of possible time resource configurations for full duplex communication, and the at least one time occasion for which transmission will be restricted is determined based on the at least one time resource configuration that the at least one time resource configured for full duplex communication is configured based on.

The second information may indicate at least one first downlink reference signal resource for which transmission of at least one downlink reference will not occur in the at least one time resource configured for full duplex communication, and at least one second downlink reference signal resource for which transmission of at least one downlink reference will occur in the at least one time resource configured for full duplex communication. The second information may indicate that for at least one time occasion at least one downlink reference signal resource will be punctured. The second information may indicate at least one of: an antenna port; or frequency resources that will be punctured.

The first information may define at least one downlink reference signal resource for the at least one downlink reference signal, and the method further comprises inhibiting uplink communication in at least one time resource configured for uplink communication, or at least one time resource configured for full duplex communication, that overlaps in time with at least one time occasion associated with the at least one downlink reference signal resource.

It can also be seen in summary that in one above example there is disclosed a method performed by a user equipment (UE) (and a corresponding UE, access network node, and method performed by an access network node), the method comprising: communicating with an access network node in at least one time resource of a plurality of time resources, wherein the plurality of time resources include at least one time resource configured for downlink communication, and at least one time resource configured for full duplex communication: receiving, from the access network node, a report configuration for at least one downlink reference signal to be reported; and reporting, to the access network node, based on the report configuration, information based on at least one measurement of at least one downlink reference signal transmitted in at least one time resource of the plurality of time resources; wherein, in a case where at least one downlink reference signal to be reported is transmitted in at least one time resource configured for full duplex communication, the reporting reports information based on at least one of: measurement in respect of at least one downlink reference signal transmitted in at least one time resource configured for downlink communication; or partial measurement in respect of at least one downlink reference signal transmitted in at least one time resource configured for full duplex communication.

The report configuration may indicate whether or not measurement of at least one downlink reference signal should be restricted to at least one downlink reference signal transmitted within a time window.

In a case where the report configuration indicates that measurement of the at least one downlink reference should be restricted to at least one downlink reference signal transmitted within the time window, and at least one downlink reference signal to be reported is transmitted in at least one time resource configured for full duplex communication that occurs within the time window the following may occur.

The reporting may report information based on measurement in respect of at least one downlink reference signal transmitted in at least one time resource configured for downlink communication that is outside the time window, and the reporting may omit reporting of information based on measurement in respect of at least one downlink reference signal transmitted in the at least one time resource configured for full duplex communication that occurs within the time window. The reporting may omit reporting in respect of the that time window.

The reporting may report information: based on partial measurement in respect of at least one downlink reference signal transmitted in at least one time resource configured for full duplex communication that occurs within the time window, and based on partial measurement in respect of at least one downlink reference signal transmitted in at least one time resource configured for downlink communication that does not occur within the time window.

The reporting may report information based on partial measurement in respect of at least one downlink reference signal transmitted in at least one time resource configured for full duplex communication that occurs within the time window, and the reporting may omit reporting of information based on measurement in respect of any downlink reference signal transmitted in a time resource that occurs outside the time window.

In a case where the report configuration indicates that measurement of the at least one downlink reference should not be restricted to at least one downlink reference signal transmitted within the time window, and at least one downlink reference signal to be reported is transmitted in at least one time resource configured for full duplex communication, the following may occur.

The reporting may report information based on measurement in respect of at least one downlink reference signal transmitted in at least one time resource configured for downlink communication, and the reporting may omit reporting of information based on measurement in respect of at least one downlink reference signal transmitted in at least one time resource configured for full duplex communication. The reporting may report information: based on measurement in respect of at least one downlink reference signal transmitted in at least one time resource configured for full duplex communication, and based on measurement in respect of at least one downlink reference signal transmitted in at least one time resource configured for downlink communication.

It can also be seen in summary that in one above example there is disclosed a method performed by a user equipment (UE) (and a corresponding UE, access network node, and method performed by an access network node), the method comprising: communicating with an access network node in at least one time resource of a plurality of time resources, wherein the plurality of time resources include at least one time resource configured for uplink communication, and at least one time resource configured for full duplex communication; wherein the communicating includes performing at least one uplink transmission in the at least one time resource configured for full duplex communication based on a first uplink transmission configuration defined for uplink transmission in the at least one time resource configured for full duplex communication, and the first uplink transmission configuration is different to a second uplink transmission configuration defined for uplink transmission in the at least one time resource configured for uplink communication.

The first uplink transmission configuration may include at least one power value to be applied in respect of uplink transmission in the at least one time resource configured for full duplex communication that is different to at least one corresponding power value, included in the second uplink transmission configuration, to be applied in respect of uplink transmission in the at least one time resource configured for uplink communication.

The method may further comprise receiving an indication of the at least one power value from the access network node. The indication of the at least one power value may indicate at least one power state, of a plurality of different possible power states, to be applied in respect of the uplink transmission in the at least one time resource configured for full duplex communication. The at least one power value may indicate at least one power offset to be applied in respect of the uplink transmission in the at least one time resource configured for full duplex communication. The indication of the at least one power value may indicate at least one specific power value to be applied in respect of the uplink transmission in the at least one time resource configured for full duplex communication. The indication of the at least one power value from the access network node may indicate a different respective power value to be applied in respect of uplink transmissions in each of a plurality of uplink channels.

The first uplink transmission configuration may include an encoding rule to be applied in respect of uplink transmission in the at least one time resource configured for full duplex communication that is different to another encoding rule, included in the second uplink transmission configuration, to be applied in respect of uplink transmission in the at least one time resource configured for uplink communication. The first uplink transmission configuration may include a number of repetitions to be applied in respect of uplink transmission in the at least one time resource configured for full duplex communication that is different to another number of repetitions, included in the second uplink transmission configuration, to be applied in respect of uplink transmission in the at least one time resource configured for uplink communication. The first uplink transmission configuration may include a random access channel (RACH) format to be applied in respect of uplink transmission in the at least one time resource configured for full duplex communication that is different to another RACH format, included in the second uplink transmission configuration, to be applied in respect of uplink transmission in the at least one time resource configured for uplink communication.

Various other modifications will be apparent to those skilled in the art and will not be described in further detail here.

Part of or all the foregoing aspects can be described as in the following appendixes, but the present disclosure is not limited thereto.

### (Supplementary Note 1)

A method performed by a user equipment (UE), the method comprising: receiving, from an access network node:
first information indicating a first configuration related to transmission of a reference signal in a first time resource configured for a first communication scheme, and
second information indicating a second configuration related to transmission of a reference signal in a second time resource configured for a second communication scheme; and
performing measurement of a reference signal transmitted in a time resource based on:
the first information,
the second information, and
a communication scheme configuring the time resource used in transmitting the reference signal.

### (Supplementary Note 2)

The method according to Supplementary Note 1, wherein
the first communication scheme corresponds to time division duplex communication, and
the second communication scheme corresponds to full duplex communication.

### (Supplementary Note 3)

The method according to Supplementary Note 1 or 2, further comprising:
receiving downlink control information indicating which of the first configuration or the second configuration is applicable for measurement corresponding to the downlink control information, and wherein
the performing the measurement is performed based on the downlink control information.

### (Supplementary Note 4)

The method according to any one of Supplementary Notes 1 to 3, wherein
the second information indicates that the reference signal in at least the second time resource configured for the second communication scheme will not be transmitted.

### (Supplementary Note 5)

The method according to Supplementary Note 4, wherein
the at least the second time resource is represented as a punctured resource from first time resources for the first communication scheme.

### (Supplementary Note 6)

The method according to any one of Supplementary Notes 1 to 3, wherein
the second information includes:
   information indicates that the reference signal in at least the second time resource configured for the second communication scheme should not be transmitted; and
   information indicates that the reference signal in other at least the second time resource configured for the second communication scheme should be transmitted.

### (Supplementary Note 7)

The method according to any one of Supplementary Notes 1 to 3, wherein
the second information indicates, for a given time resource, that the UE should not perform uplink, UL, transmissions during UL symbols/slots that overlap with the second time resource configured for the second communication scheme or a given time resource for transmission of a reference signal.

### (Supplementary Note 8)

The method according to any one of Supplementary Notes 1 to 3, wherein
the second information indicates, for a given time resource, whether uplink, UL, transmissions for UL symbol/slot types are valid during the second time resource configured for the second communication scheme.

### (Supplementary Note 9)

The method according to any one of Supplementary Notes 1 to 8, wherein
the first information and the second information indicates at least one of:
   a power value for transmission of the reference signal,
   an antenna port configuration for transmission of the reference signal, or
   a frequency resource configuration for transmission of the reference signal.

### (Supplementary Note 10)

The method according to any one of Supplementary Notes 1 to 9, wherein
in a case where a measurement result related to transmission of the reference signal transmitted in the first time resource is available and a measurement result related to transmission of the reference signal transmitted in the second time resource is available as a last measurement, the method comprises:
deriving a measurement report value based on:
   a) the measurement result related to the transmission of the reference signal transmitted in the first time resource only,
   b) the measurement result related to the transmission of the reference signal transmitted in the second time resource only, with assuming at least one of:
      reducing a number of antenna ports for deriving, or
      reducing a number of frequency resources for deriving,
   c) a partial measurement result related to the transmission of the reference signal transmitted in the first time resource and a partial measurement result related to the transmission of the reference signal transmitted in the second time resource with assuming at least one of:
      respective antenna ports for deriving are different each other, or
      frequency resources for deriving are different each other, or
   d) both the measurement result related to the transmission of the reference signal transmitted in the first time resource and the measurement result related to the transmission of the reference signal transmitted in the second time resource, or
dropping the measurement report value.

### (Supplementary Note 11)

A method performed by a user equipment (UE), the method comprising: performing a uplink transmission in a second time resource configured for a second communication scheme based on a second uplink transmission configuration defined for uplink transmission in the second time resource configured for the second communication scheme,
wherein the second uplink transmission configuration is different from a first uplink transmission configuration defined for uplink transmission in a first time resource configured for a first communication scheme.

### (Supplementary Note 12)

The method according to Supplementary Note i1, wherein
the second communication scheme corresponds to full duplex communication, and
the first communication scheme corresponds to time division duplex communication.

### (Supplementary Note 13)

The method according to Supplementary Note 11 or 12, wherein
the second uplink transmission configuration includes a power value to be applied in respect of uplink transmission in the second time resource configured for the second communication scheme that is different from another power value, included in the first uplink transmission configuration, to be applied in respect of uplink transmission in the first time resource configured for the first communication scheme.

### (Supplementary Note 14)

The method according to Supplementary Note 13, further comprising:
receiving an indication of the power value from an access network node.

### (Supplementary Note 15)

The method according to Supplementary Note 14, wherein
the indication of the power value indicates a specific power value to be applied in respect of the uplink transmission in the second time resource configured for the second communication scheme.

### (Supplementary Note 16)

The method according to any one of Supplementary Notes 11 to 15, wherein
the second uplink transmission configuration includes an encoding rule to be applied in respect of uplink transmission in the second time resource configured for the second communication scheme that is different from another encoding rule, included in the first uplink transmission configuration, to be applied in respect of uplink transmission in the first time resource configured for the first communication scheme.

### (Supplementary Note 17)

The method according to any one of Supplementary Notes 11 to 16, wherein
the second uplink transmission configuration includes a number of repetitions to be applied in respect of uplink transmission in the second time resource configured for the second communication scheme that is different from another number of repetitions, included in the first uplink transmission configuration, to be applied in respect of uplink transmission in the first time resource configured for the first communication scheme.

### (Supplementary Note 18)

The method according to any one of Supplementary Notes 11 to 17, wherein
the second uplink transmission configuration includes a random access channel (RACH) format to be applied in respect of uplink transmission in the second time resource configured for the second communication scheme that is different from another RACH format, included in the first uplink transmission configuration, to be applied in respect of uplink transmission in the first time resource configured for the first communication scheme.

### (Supplementary Note 19)

A method performed by an access network node, the method comprising: transmitting, to a user equipment (UE):
first information indicating a first configuration related to transmission of a reference signal in a first time resource configured for a first communication scheme, and
second information indicating a second configuration related to transmission of a reference signal in a second resource configured for a second communication scheme; and
receiving, from the UE, a report of measurement of a reference signal transmitted in a time resource,
wherein the report includes information based on:
   the first information,
   the second information, and
   a communication scheme configuring the time resource used in transmitting the reference signal.

### (Supplementary Note 20)

A method performed by an access network node, the method comprising:
receiving, from a user equipment (UE), a uplink transmission in a second time resource configured for a second communication scheme based on a second uplink transmission configuration defined for uplink transmission in the second time resource configured for the second communication scheme, wherein the second uplink transmission configuration is different from a first uplink transmission configuration defined for uplink transmission in a first time resource configured for a first communication scheme.

### (Supplementary Note 21)

A user equipment (UE) comprising:
means for receiving, from an access network node:
   first information indicating a first configuration related to transmission of a reference signal in a first time resource configured for a first communication scheme, and
   second information indicating a second configuration related to transmission of ta reference signal in a second time resource configured for a second communication scheme; and
means for performing measurement of a reference signal transmitted in a time resource based on:
the first information,
the second information, and
a communication scheme configuring the time resource used in transmitting the reference signal.

### (Supplementary Note 22)

A user equipment (UE) comprising:
means for performing a uplink transmission in a second time resource configured for a second communication scheme based on a second uplink transmission configuration defined for uplink transmission in the second time resource configured for the second communication scheme,
wherein the second uplink transmission configuration is different from a first uplink transmission configuration defined for uplink transmission in a first time resource configured for a first communication scheme.

### (Supplementary Note 23)

An access network node comprising:
means for transmitting, to a user equipment (UE):
   first information indicating a first configuration related to transmission of a reference signal in a first time resource configured for a first communication scheme, and
   second information indicating a second configuration related to transmission of a reference signal in a second time resource configured for a second communication scheme; and
means for receiving, from the UE, a report of measurement of a reference signal transmitted in a time resource,
wherein the report includes information based on:
the first information,
the second information, and
   a communication scheme configuring the time resource used in transmitting the reference signal.

### (Supplementary Note 24)

An access network node comprising:
means for receiving, from a user equipment (UE), a uplink transmission in a second time resource configured for a second communication scheme based on a second uplink transmission configuration defined for uplink transmission in the second time resource configured for the second communication scheme,
wherein the second uplink transmission configuration is different from a first uplink transmission configuration defined for uplink transmission in a first time resource configured for a first communication scheme.

This application is based upon and claims the benefit of priority from United Kingdom Patent Application No. 2211851.7, filed on Aug. 12, 2022, the disclosure of which is incorporated herein in its entirety by reference.

### REFERENCE SIGNS LIST

1 COMMUNICATION SYSTEM
3 UE
5 BASE STATION
7 CORE NETWORK
9 CELL
10 CPF
11 UPF
20 EXTERNAL DATA NETWORK
31 TRANSCEIVER CIRCUIT
33 ANTENNA
35 USER INTERFACE
37 CONTROLLER
39 MEMORY
41 OPERATING SYSTEM
43 COMMUNICATIONS CONTROL MODULE
45 MEASUREMENT SIGNAL MANAGEMENT MODULE
47 UPLINK POWER CONTROL MODULE
51 TRANSCEIVER CIRCUIT
53 ANTENNA
55 CORE NETWORK INTERFACE
57 CONTROLLER
59 MEMORY
61 OPERATING SYSTEM
63 COMMUNICATIONS CONTROL MODULE
65 MEASUREMENT SIGNAL MANAGEMENT MODULE
71 TRANSMISSION PARAMETER MANAGEMENT MODULE
73 SYSTEM INFORMATION MODULE
710 ANTENNA PANEL
712 ANTENNA ELEMENT

What is claimed is:

1. A method performed by a user equipment (UE), the method comprising:
receiving, from an access network node:
first information indicating a first configuration related to transmission of a reference signal in a first time resource configured for a non-subband full duplex (SBFD), and
second information indicating a second configuration related to transmission of a reference signal in a second time resource configured for a SBFD; and
performing measurement of a reference signal transmitted in a time resource based on:
the first information,
the second information, and
third information indicating whether a respective time resource is valid for-used in transmitting the reference signal.

2. (canceled)

3. The method according to claim 1, further comprising:
receiving downlink control information indicating which of the first configuration or the second configuration is applicable for measurement corresponding to the downlink control information, and wherein
the performing the measurement is performed based on the downlink control information.

4. The method according to claim 1, wherein
the second information indicates that the reference signal in at least the second time resource configured for the SBFD will not be transmitted.

5. The method according to claim 4, wherein
the at least the second time resource is represented as a punctured resource from first time resources for the non-SBFD.

6. The method according to claim 1, wherein
the second information includes:
information indicates that the reference signal in at least the second time resource configured for the SBFD should not be transmitted; and
information indicates that the reference signal in other at least the second time resource configured for the SBFD should be transmitted.

7. The method according to claim 1, wherein
the second information indicates, for a given time resource, that the UE should not perform uplink (UL) transmissions during UL symbols/slots that overlap with the second time resource configured for the SBFD or a given time resource for transmitting the reference signal.

8. The method according to claim 1, wherein
the second information indicates, for a given time resource, whether uplink (UL) transmissions for UL symbol/slot types are valid during the second time resource configured for the SBFD.

9. The method according to claim 1, wherein
the first information and the second information indicate at least one of:
a power value for transmission of the reference signal,
an antenna port configuration for transmission of the reference signal, or
a frequency resource configuration for transmission of the reference signal.

10. The method according to claim 1, wherein
in a case where a measurement result related to transmission of the reference signal transmitted in the first time resource is available and a measurement result related to transmission of the reference signal transmitted in the second time resource is available as a last measurement, the method comprises:
deriving a measurement report value based on:
a) the measurement result related to the transmission of the reference signal transmitted in the first time resource only,
b) the measurement result related to the transmission of the reference signal transmitted in the second time resource only, with assuming at least one of:
reducing a number of antenna ports for deriving, or
reducing a number of frequency resources for deriving,
c) a partial measurement result related to the transmission of the reference signal transmitted in the first time resource and a partial measurement result related to the transmission of the reference signal transmitted in the second time resource with assuming at least one of:
respective antenna ports for deriving are different each other, or
frequency resources for deriving are different each other, or
d) both the measurement result related to the transmission of the reference signal transmitted in the first time resource and the measurement result related to the transmission of the reference signal transmitted in the second time resource, or
dropping the measurement report value.

11-12. (canceled)

13. The method according to claim 1, wherein
the second information includes a power value to be applied in respect of uplink transmission in the second time resource configured for the SBFD that is different from another power value, included in the first information, to be applied in respect of uplink transmission in the first time resource configured for the non-SBFD.

14. The method according to claim 13, further comprising:
receiving an indication of the power value from an access network node.

15. The method according to claim 14, wherein
the indication of the power value indicates a specific power value to be applied in respect of the uplink transmission in the second time resource configured for the SBFD.

16. The method according to claim 1, wherein
the second information includes an encoding rule to be applied in respect of uplink transmission in the second time resource configured for the SBFD that is different from another encoding rule, included in the first information, to be applied in respect of uplink transmission in the first time resource configured for the non-SBFD.

17. The method according to claim 1, wherein
the second information includes a number of repetitions to be applied in respect of uplink transmission in the second time resource configured for the SBFD that is different from another number of repetitions, included in the first information, to be applied in respect of uplink transmission in the first time resource configured for the non-SBFD.

18. The method according to claim 1, wherein
the second information includes a random access channel (RACH) format to be applied in respect of uplink transmission in the second time resource configured for the SBFD that is different from another RACH format, included in the first information, to be applied in respect of uplink transmission in the first time resource configured for the non-SBFD.

19. A method performed by an access network node, the method comprising:
transmitting, to a user equipment (UE):
first information indicating a first configuration related to transmission of a reference signal in a first time resource configured for a non-subband full duplex (SBFD), and
second information indicating a second configuration related to transmission of a reference signal in a second resource configured for a SBFD; and
receiving, from the UE, a report of measurement of a reference signal transmitted in a time resource,
wherein the report includes information based on:
the first information,
the second information, and
third information indicating whether a respective time resource is valid for transmitting the reference signal.

20. (canceled)

21. A user equipment (UE) comprising:
at least one memory configured to store instructions; and
at least one processor configured to execute the instructions to:
receive, from an access network node:
first information indicating a first configuration related to transmission of a reference signal in a first time resource configured for a non-subband full duplex (SBFD), and
second information indicating a second configuration related to transmission of the reference signal in a second time resource configured for a SBFD; and
perform measurement of a reference signal transmitted in a time resource based on:
the first information,
the second information, and
third information indicating whether a respective time resource is valid for transmitting the reference signal.

22. (canceled)

23. An access network node comprising:
at least one memory configured to store instructions; and
at least one processor configured to execute the instructions to:
transmit, to a user equipment (UE):
first information indicating a first configuration related to transmission of a reference signal in a first time resource configured for a non-subband full duplex (SBFD), and
second information indicating a second configuration related to transmission of a reference signal in a second time resource configured for a SBFD; and
receive, from the UE, a report of measurement of a reference signal transmitted in a time resource,
wherein the report includes information based on:
the first information,
the second information, and
third information indicating whether a respective time resource is valid for transmitting the reference signal.

24. (canceled)

25. The method according to claim 1, wherein
the third information indicates that:
transmitting the reference signal is restricted to the first time resource only or the second time resource only, or
transmitting the reference signal can be in both the first time resource and the second time resource.

26. The method according to claim 1, wherein
at least one frequency resource in the second time resource is excluded for transmitting the reference signal.
